(19) United States
(12) Patent Application Publication
(10) Pub. No.: US 2008/0212613 A1
(43) Pub. Date: Sep. 4, 2008

(54) Multilink meshed transport service

(76) Inventors: Terry D. Perkinson, Roseville, CA (US); Ballard C. Bare, Auburn, CA (US)

Correspondence Address: OKAMOTO & BENEDICTO, LLP, P.O. BOX 641330, SAN JOSE, CA, 95164, US

(21) Appl. No.: 12/072,877

(22) Filed: Feb. 28, 2008

Related U.S. Application Data
(60) Provisional application No. 60/904,466, filed on Mar. 2, 2007.

(51) Int. Cl. H04J 3/24

(52) U.S. Cl. 370/475

(57) ABSTRACT

One embodiment relates to a method of transporting data packets between a plurality of transport units in a building. Transmit flows are created and associated with source-destination address pairs of new data streams received from outside a network of the transport units. A separate sequence space is provided for each transmit flow. The transmission of the data packets belonging to a same transmit flow is advantageously spread among multiple link-layer links. Other embodiments, aspects and features are also disclosed.

### CROSS REFERENCE TO RELATED APPLICATIONS

The present application claims the benefit of U.S. Provisional Patent Application No. 60/904,466, entitled “Multilink Meshed Transport Service,” filed Mar. 2, 2007 by Terry D. Perkinson and Ballard C. Bare, the disclosure of which is hereby incorporated by reference.

### BACKGROUND OF THE INVENTION

1. Technical Field

The present disclosure relates to apparatus and methods for data communications.

2. Description of the Background Art

The data link layer (OSI network layer 2) encodes and decodes data packets into bits and also provides transmission protocol knowledge and management. The data link layer may be divided into two sub-layers: the media access control (MAC) layer and the logical link control (LLC) layer. The MAC sub-layer controls how a computer on the network gains access to the data and permission to transmit it. The LLC sub-layer (“the link layer”) controls frame synchronization, flow control and error checking.

Network trunking is a link-layer method in which multiple physical links are connected between two network devices in order to increase aggregate throughput and provide redundancy. FIG. 1 is a schematic diagram depicting conventional network trunking. FIG. 1 shows multiple trunk links (“trunk ports”) 102 between two trunking devices 104, each trunking device being connected to multiple hosts 106.

Typically, a network trunk uses an algorithm that takes the source address, destination address, or combination of the both address and does modulo of this value on the number of links that are up to decide which link to use. Hence, traffic to the same source destination pair will always use the same physical link as long as that link is up.

Using the same physical link is required to maintain packet order in network trunking. Resiliency is achieved by changing the modulo size on the number of links that are up. During a link down event there is a small chance of lost traffic since a given source destination pair may have one or more packets in flight when the link went down. Load balancing for trunks occurs only when there are many source destination pairs so that the probability of link usage averages out in hopefully equal amounts over all the source destinations pairs using the trunk.

Therefore, as determined by the applicant, the current methods of network trunking have the following problems and limitations. First, load balancing of traffic across the trunk is statistical in nature and requires a large number of different source destination address pairs traverse the trunk. With small numbers of source destination pair's anomalies can occur where the bulk of the traffic only goes over one link and leaves the other links unused. For example, a particularly talkative source destination pair may easily skew the load balancing in trunks.

Second, link speeds of all the physical links in network trunking must all have the same bandwidth or packets may be dropped since no consideration of the link bandwidth is taken into account when determining which physical link to use. Therefore, trunking cannot be used with links whose bandwidth can dynamically change with time.

Third, no method is provided within trunking to recover packets lost across the link. For example, if a physical goes down, packets sent on that link are lost and only once the hardware/software realize that the link is down will future packets take a different path.

Fourth, trunking today is only used in point-to-point connections and will not work in shared broadcast media were multiple devices are connected to the same sets of links.

It is highly desirable to improve methods and apparatus for data communications. In particular, it is highly desirable to overcome the above-discussed problems and limitations of network trunking.

### SUMMARY

One embodiment relates to a method of transporting data packets between a plurality of transport units in a building. Transmit flows are created and associated with source-destination address pairs of new data streams received from outside a network of the transport units. A separate sequence space is provided for each transmit flow. The transmission of the data packets belonging to a same transmit flow is advantageously spread among multiple link-layer links.

Other embodiments, aspects and features are also disclosed.

### BRIEF DESCRIPTION OF THE DRAWINGS

FIG. 1 depicts conventional network trunking.

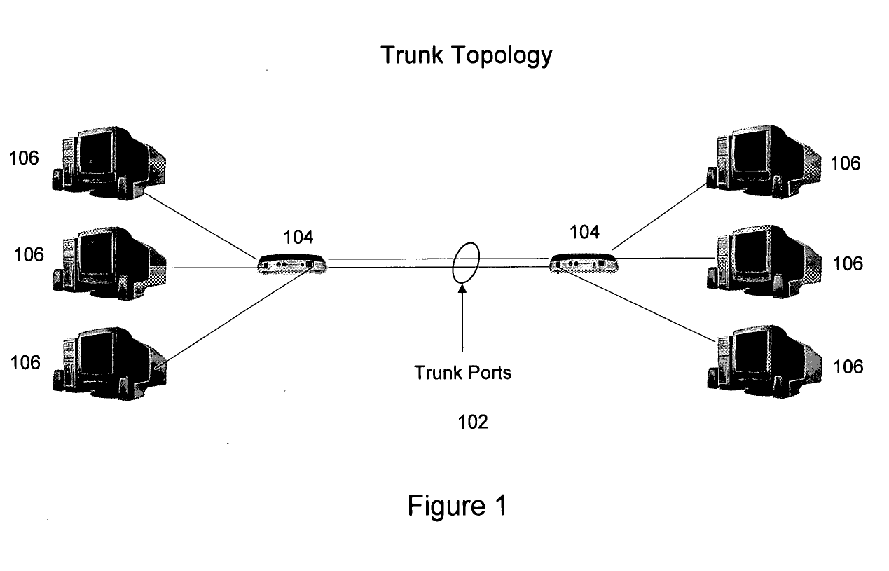

FIG. 2 depicts MMTS in accordance with an embodiment of the invention.

FIG. 3 illustrates IP packet modification in accordance with an embodiment of the invention.

FIG. 4 illustrates IP packet modification in accordance with another embodiment of the invention.

FIG. 5 illustrates generic packet modifications in accordance with an embodiment of the invention.

FIG. 6 illustrates ARP packet modifications in accordance with an embodiment of the invention.

FIG. 7 illustrates MTTS discovery in accordance with an embodiment of the invention.

FIG. 8 illustrates transmit and receive flow connections using a per flow sequence space in accordance with an embodiment of the invention.

FIG. 9 illustrates unicast flow connection establishment and data transmission in accordance with an embodiment of the invention.

FIG. 10 illustrates multicast flow establishment and data transmission in accordance with an embodiment of the invention.

FIG. 11 illustrates packet retransmission in accordance with an embodiment of the invention.

FIG. 12 is a latency measurement flow chart in accordance with an embodiment of the invention.

FIG. 13 is a latency measurement time chart in accordance with an embodiment of the invention.

FIG. 14 illustrates Load Balance Ratio calculation procedural steps in accordance with an embodiment of the invention.

FIG. 15 illustrates bandwidth calculation procedural steps in accordance with an embodiment of the invention.

FIG. 16 is a packet transmission and queuing flow diagram in accordance with an embodiment of the invention.

FIG. 17 is a graceful degradation flow diagram in accordance with an embodiment of the invention.

FIG. 18 illustrates bandwidth aggregation in accordance with an embodiment of the invention.

### DETAILED DESCRIPTION

### Multilink Meshed Transport Service (MMTS)

The Multilink Meshed Transport Service (MMTS transport service or “Riavo” transport service) disclosed herein solves the above problems and limitations of standard network trunking. Like trunking, the MMTS is a link layer protocol.

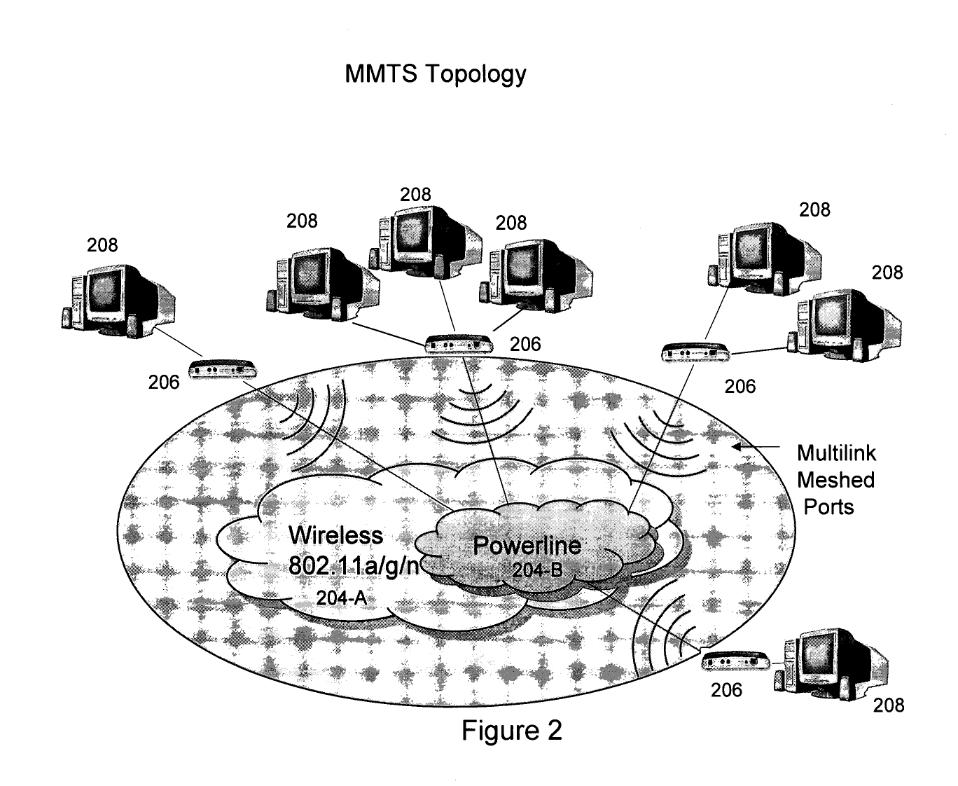

FIG. 2 is a schematic diagram depicting MMTS. FIG. 2 shows “multilink meshed ports” providing communications over different possible networking technologies (shown are wireless 801.11a/g/n 204-A and power line 204-B technologies, for example) between multiple MMTS units 206, each MMTS unit being connected to one or multiple hosts 208.

In some embodiments of this invention, all the MMTS units intercommunicate directly with each other. For example, the network topology for the MMTS units may comprise a mesh topology. In a full mesh topology, each MMTS unit may connect directly to each of the other MMTS units in the network mesh. In a partial mesh topology, some MMTS units may not be directly connected.

In other embodiments, a primary may be chosen (or configured) as in the case where one unit acts as a wireless access point (primary unit) and all the other units act as wireless clients (slave units). In this case all traffic between units goes through the primary unit. If the MMTS transport service is implemented with a topology in which some links are in a shared network medium and slave units are seen by other slave units (e.g., the shared network medium may be a HomePlug network), then a mechanism may be configured to force traffic from slave units through the primary unit. One way to do this is to use a different Ethernet type for data sent by a slave unit verses data sent by the primary unit. Using this method a slave unit recognizes traffic sent by another slave unit and ignores it, allowing only traffic sent by the primary unit to be processed. (Other mechanism, including tunneled headers may be used although tunneled headers would require more overhead.) Although it is possible to allow direct slave unit to slave unit communication, extra protocol would be required to inform the primary unit which packets have been sent directly between slave units and which have been sent through the primary unit, adding a lot of complexity to the solution.

### Encoding Transport Information

MMTS encodes sequence information into the packets. The sequence information may be advantageously utilized such that packets from a given source-destination pair may be dynamically sent across different physical links while maintaining packet order. This is particularly true if there are different link latencies for the different links. In addition, encoding the sequence information effectively marks the packets, such that lost packets may be recognized and recovered.

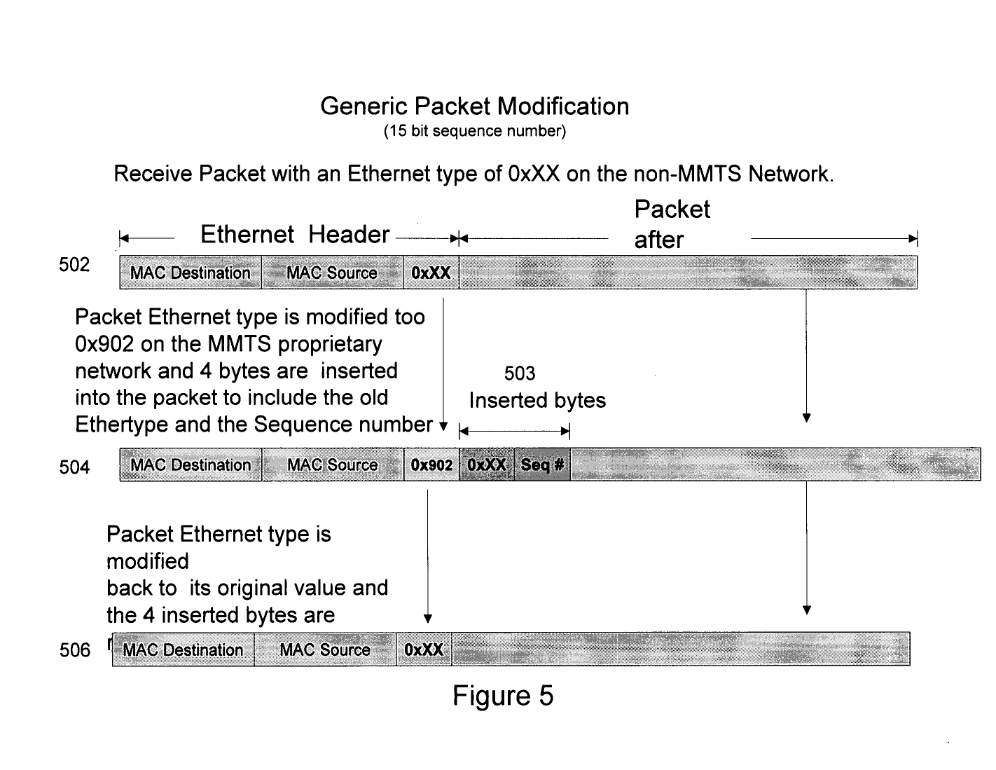

One approach to encoding sequence information into the packets involves placing a special header on the front of the packets (e.g., to form a packet tunnel). However, doing so would increase the packet size. It would also potentially create packets that would need to be fragmented into multiple packets. Such fragmentation would end up using much more CPU and link bandwidth. Another method that can generically be used is to insert 4 bytes into the packet header as shown in FIG. 5.

To avoid these issues, the MMTS protocol preferably uses a different approach. This approach uses spare room in the packets to encode its sequence information.

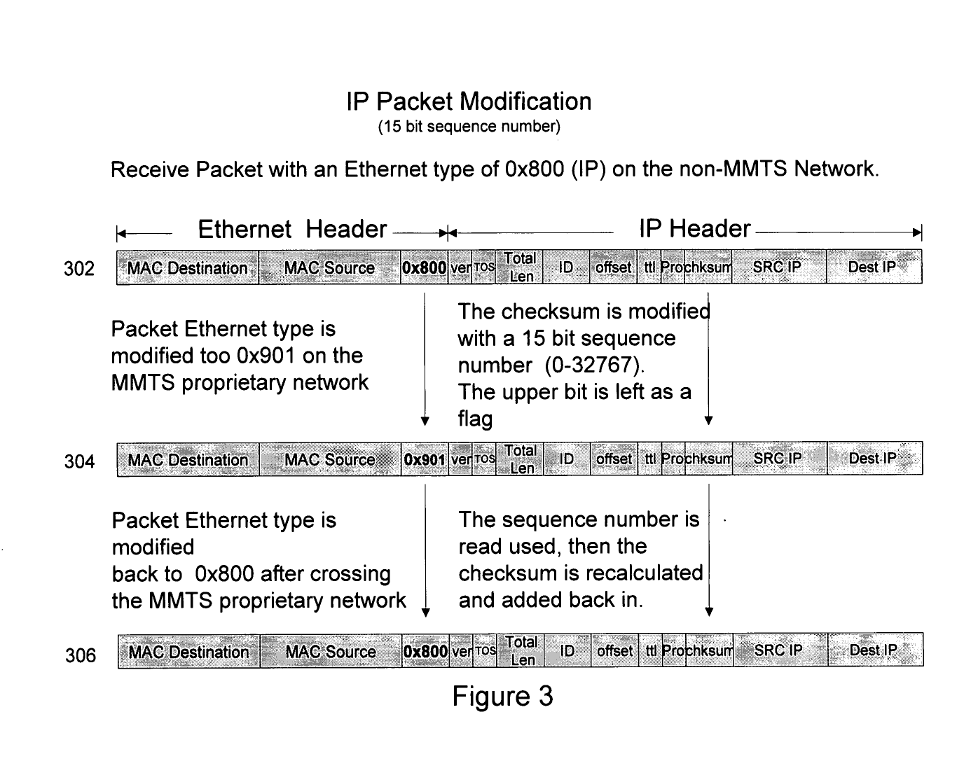

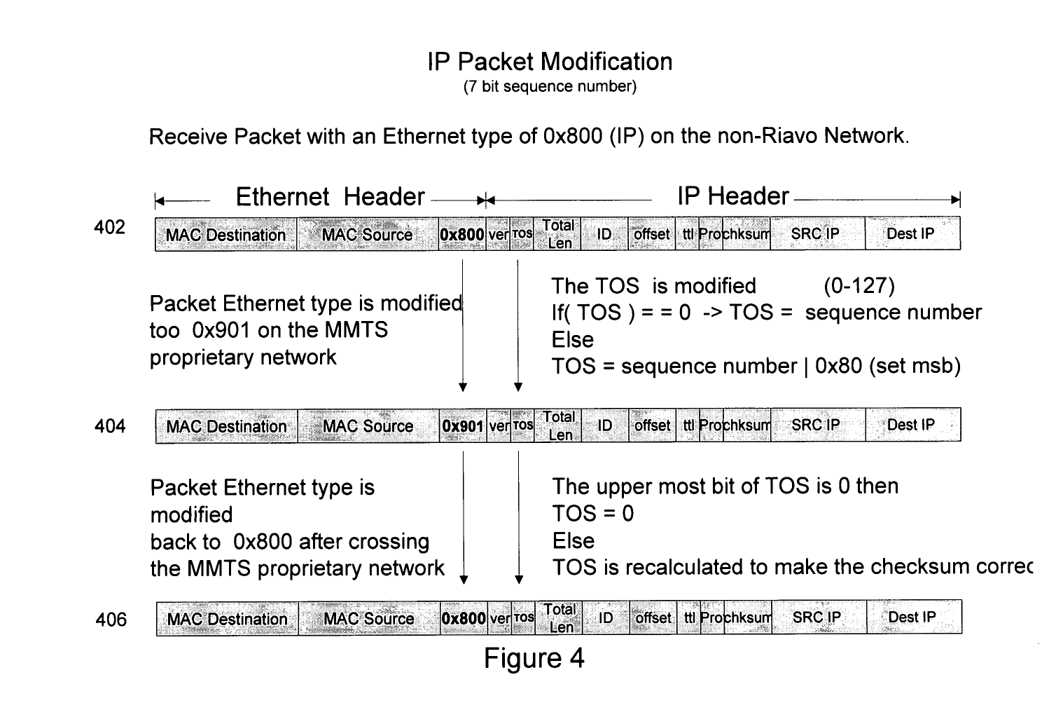

In one implementation of the MMTS protocol, only IPv4 packets are sent using the multilink transport. Other packet types are sent much like a conventional trunk, where the same source-destination pair is sent across the same physical interface. Nevertheless, methods similar to those used by the MMTS protocol for IPv4 packets may also be applied to other packet types in different implementations. In a hybrid implementation, the methods used for IPv4 encapsulation discussed below are used for IPv4 packets (see FIGS. 3 and 4), and the method of inserting a 4 byte field is used for Non-IPV4 packets. (see FIG. 5).

### Per Flow Sequence Space

The sequence number is advantageously used to make sure packets for a given flow are forwarded in order and indicates which packets have not yet been received so that the transmitter can retransmit the appropriate packets should an acknowledgement not be received in time.

In one specific implementation of the MMTS protocol, a 15-bit sequence space size is utilized. In other implementations, a different sequence space size may be used, such as, for example, a 7-bit sequence space size. The appropriate sequence space size for a network depends on the propagation delays in the network, among other factors

The 15-bit sequence space size allows for sequence numbers from 0 through 32,767. As packets for a given flow are transmitted the sequence number increments up to 32767 then wraps back to 0.

Using a 15-bit sequence space size (or larger) is advantageous in that long packet latencies (for example, greater than one second) may be recognized on a given flow. A large size sequence space also allows for a fairly large credit window to help reduce acknowledgement (ACK) frequency and hence ACK overhead.

For example, consider the transmission of a specific packet (the original packet) from a source MMTS unit to a destination MMTS unit, where the transmission is substantially delayed. Consider further that the source unit recognizes the packet is delayed beyond its retransmission interval (the time interval before the source unit attempts retransmission). As such, the source unit re-transmits the packet (the re-transmitted packet) to the destination unit via an alternate link. Consider that this re-transmission is successful and that the credit window then moves beyond the sequence number of that specific packet.

Thereafter, if the original packet finally arrives at the destination unit due to a long latency, the original packet is generally recognized as out of sequence and dropped. There is only a miniscule chance of the original packet arriving such that it just happens to arrive inside the credit window after the sequence space has wrapped one or more times. The chance is small because the sequence space is large compared to the credit window.

The sequence space is used on a per flow basis (each source destination MAC address pair has its own 15 bit sequence space). Using the sequence space per flow allows finer control for priority queuing than could be achieved if the sequence space was just between peer MMTS units. This is also useful when flows are started before the destination address location is known.

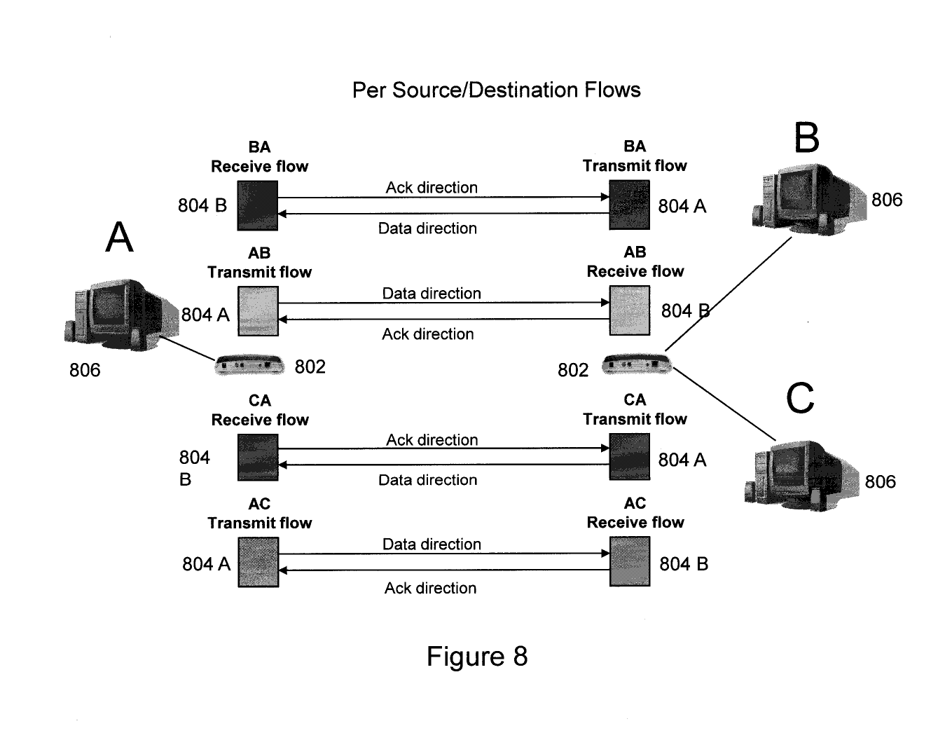

FIG. 8 illustrates the per flow sequence space concept with separate flows for each source destination address pair. The figure shows multiple flows between two MMTS units (802). Each flow consist of a transmit side (804A) and a receive side (804B). Note: flows are unidirectional and that two flows are created to talk bi-directionally between sets of end stations (806).

### IPv4 Encoding

As discussed above, MMTS may be used to send IPv4, and potentially other types of network (layer 3) packets. In this section, we discuss the encoding of IPv4 packets for transmission via MMTS.

To encode the transport information into an IPv4 packet, the Ethernet type is modified with a type that signifies that this is a modified IPv4 packet. In one implementation, 0x0901 is used for that purpose (see FIGS. 3 and 4); however, any unused Ethernet type in the network this protocol is to be run in may be used.

When all traffic goes though a primary unit, a preferred embodiment of this invention uses a different Ethernet type for IP traffic sent from a primary unit to slave unit and from a slave unit to primary unit. This ensures greater control so that traffic between slave units and prevents traffic sent from a slave unit destined to the primary unit from accidentally being received by another slave unit when a shared media, such as a powerline network medium, is being used.

FIG. 3 shows the modification of an IPv4 packet in the implementation where a 15-bit sequence number is utilized in accordance with an embodiment of the invention. A packet is received with an Ethernet type 0x800, indicating an IP packet, on a non-MMTS network. As shown, the packet header 302 includes an Ethernet header and an IP header.

The Ethernet type in the Ethernet header is modified to 0x901 on the MMTS proprietary network. In addition, to encode a 15-bit sequence space, the checksum field is overwritten in the IP packet with the sequence number. The result is a modified packet header 304. After the packet crosses the MMTS proprietary network, the Ethernet type of the packet is modified back to 0x800. In addition, the sequence number is read and used, and then the checksum is recalculated and added back into the packet header 306 such that the original packet header is re-generated.

In IPv4, the checksum is only over the IP header, and the packet is protected by a CRC check in the MAC header which is over the entire packet. Using this mechanism requires the receiving side to re-calculate the IP checksum before forwarding the packet. Although a 16 bit sequence space could be used, the 15 bits are typically sufficient and has space and allows for an extra bit to be used as a flag. This flag may be used by the transmitter, for example, to inform the receiver that they have run out of credit or when traffic is backing past a threshold and needs credit to unload is buffers. If an implementation situation has sufficiently low latency, then a smaller bit sequence space may be used. For example, a 7-bit sequence space may be used.

FIG. 4 shows the modification of an IPv4 packet in the implementation where a 7-bit sequence number is utilized in accordance with an embodiment of the invention. Encoding a 7-bit sequence space may generally avoid modifying the checksum using the following procedure.

A packet is received with an Ethernet type 0x800, indicating an IP packet, on a non-MMTS network. As shown, the packet header 402 includes an Ethernet header and an IP header.

The Ethernet type in the Ethernet header is modified to 0x901 on the MMTS proprietary network. To encode the 7-bit sequence number, the implementation may overwrite the 8 bit Type of Service (TOS) field in the IPv4 packet. The upper most bit may be reserved to indicate if the TOS field was non-zero before overwriting it with the 7-bit sequence number. The result is a modified packet header 404.

After the packet crosses the MMTS proprietary network, if the upper most bit is left as zero, then the receiver only needs to change the Ethernet type back to 0x800 and zero out the TOS field before forwarding the packet with the regenerated header 406. The IP checksum field may be left untouched in this case. In the vast majority of cases today the TOS is set to zero, so very little overhead is incurred for this packet modification.

In those cases where the TOS is not zero, then the upper most bit of the TOS field is set to one. In this case, in order to create the regenerated header 406, the receiver of the encoded packets changes the Ethernet type back to 0x800 and recalculates the TOS field so that it works with the 1's complement checksum in the IP packet. This may be accomplished by setting the TOS filed to 0 and run though the IP checksum algorithm over the IP packet header. Such a procedure does add slightly more overhead to the packet processing, but in most cases the procedure is not required since the TOS is usually initially received as zero.

Other possible methods for encoding a sequence number include adding tunnel headers to the packet. Adding tunnel headers has the downside of potentially requiring packet fragmentation should the packet with the new header exceed the MTU (maximum transmission unit) of the media onto which the packets are transmitted. This alternate method for encoding a sequence number may be desirable if the protocol to encapsulate does not have any fields that would be used to encode the sequence number.

For IPv6, the flow field could be used for encoding a sequence number since this field is not typically used. IPv6 packets have an MTU of 1280 bytes so that, for most media types, the addition of an IPv6 extension header or some form of tunnel header may be added.

FIG. 5 shows the modification of a generic packet in the implementation where a 15-bit sequence number is utilized in accordance with an embodiment of the invention. This mechanism requires the insertion of 4 extra bytes into the packet header (much like an 802.1Q VLAN header). In this case, the Ethernet type of the original packet header 502 is copied into 2 of the 4 inserted bytes and the sequence number is copied into the other 2 of the inserted bytes 503. The original Ethernet type (0xXX) is then replaced with a new Ethernet type (for example, 0x902) to indicate that the MMTS (Riavo) generic encapsulation has taken place. The result is the modified packet header 504 for use on the MMTS network. When these packets are received after crossing the MMTS network, the receiver will remove the inserted bytes and replace the Ethernet type with the type that was stored in the inserted bytes so as to form the regenerated packet header 506. This mechanism will typically require the moving the MAC Ethernet addresses up by 4 bytes to make room for the header; however, most media may increase the maximum transmission unit length by 4 bytes without requiring fragmentation.

Since the above-discussed IP checksum mechanism of FIG. 3 is very fast and does not require the address move and the copies of the method of FIG. 5 the IP checksum mechanism will probably be slightly faster than this generic packet modification mechanism for IP traffic.

### ARP Encoding

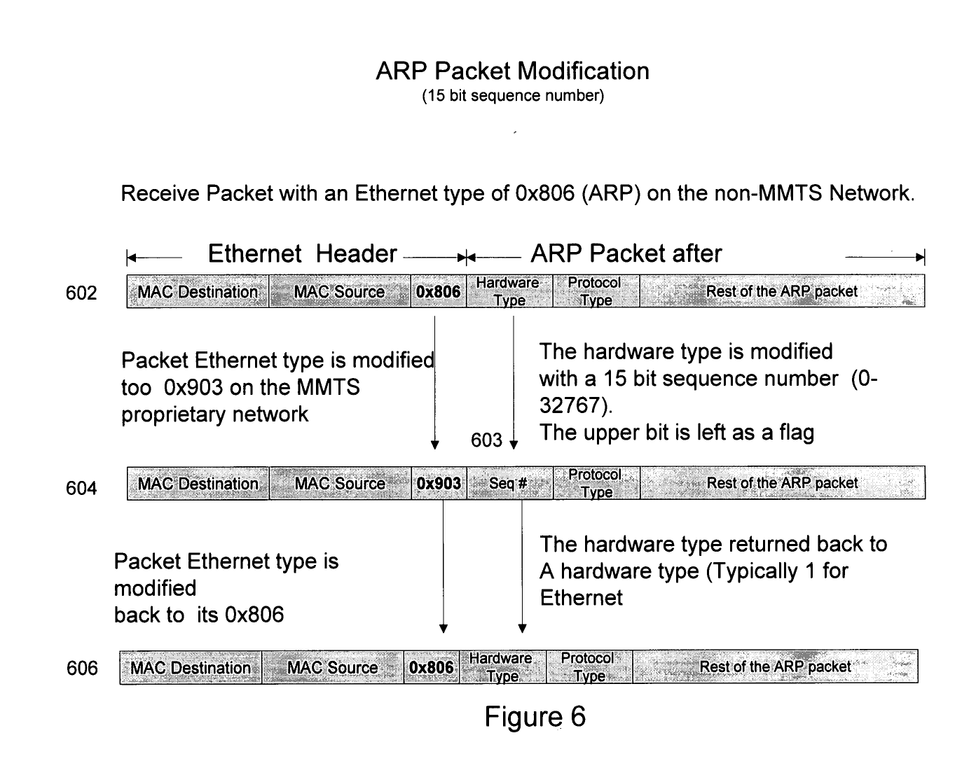

FIG. 6 shows the modification of an ARP packet in the implementation where a 15-bit sequence number is utilized in accordance with an embodiment of the invention. To encode the transport information into an Address Resolution Packet (ARP) (602), we modify the Ethernet type with a type that signifies that this is a modified ARP packet. For example, the unused Ethernet type 0x0903 may be used for that purpose; however, any unused Ethernet type in the network this protocol is to be run in could be used. The result is a modified packet header 604. To encode the 15 bit sequence space, the hardware type may be overwritten with the sequence number (603). In the case of a proprietary network where the hardware type field is used, the hardware type is known so the receiving end may readily change the value back as well as changing the Ethernet type back to 0x806 before forwarding the packet (606).

Note that the encoding of the sequence number for ARP packets is only done for reliability since no packet ordering is necessary with ARP. Hence, an alternate implementation may choose to send the ARP packets though without going through the transport service and just pick the best currently available link.

Some implementations of the MMTS protocol may merely use the generic encapsulation mechanism discussed above (see FIG. 5) and decode ARP entries from the packets for use for address learning.

Note that decoding the ARP packets is useful for learning both source MAC and IP addresses which may be used later when establishing a flow as described below. Preferred embodiments of this transport implementation learn the location of the addresses so that traffic is directed and not broadcast to all locations.

### Transport Connection Instances

In a preferred embodiment of this transport service, a connection instance is defined for each unique source-destination MAC address pair (from here on referred to as a flow or transmit flow). Alternate embodiments may base the flow on other information, such as source-destination IP address pairs. A hybrid approach may also be used in which IP traffic uses an IP source destination address and non-IP traffic uses the MAC source destination address. Using the IP source destination address for IP specific flows has the added benefit recognizing different flows for traffic that is arriving through an IP router (and/or a NAT device) since this traffic would all have the same source MAC address. This finer granularity may be used to apply different characteristics to traffic that is sourced or destined to or from machines on the far side of routers.

In Enterprise situations, a flow may also be defined using additional fields such as UDP or TCP ports.

Each flow has its own independent sequence number space. The transmission end will encode the sequence number for a particular flow using the sequence number space (FIG. 8). The receive side will decode the information and acknowledge received packets. The acknowledgement will indicate the next expected sequence space, and the amount of credit available to send further packets.

Different flows may be configured with different characteristics (e.g., non-IP flows may have lower priority, specific UDP or TCP ports may be used to define more or less buffering when a flow is established, etc). This may be particularly useful for voice versus video flows. Possible flow profiles may include, retransmission timer interval, buffering, packet priority, credit the receive side will issue, number of retransmission before a flow is dropped, etc.

### Discovery of Peer Units

In an MMTS network having a mesh topology, all the peer MMTS units need to be discovered (or manually configured). Discovery of MMTS peer units may be accomplished by sending a special protocol packet out to identify a given unit and request other units to reply. This protocol may have the following uses (some of which may be optional).

(i) Discovering peer MMTS units.

(ii) Discovering which links are connected to the network of MMTS units.

(iii) Distributing a unique identifier for each unit, typically, a MAC address. In addition, a smaller value may be negotiated by a primary unit for slave units to use for quick identification of a peer unit for other packet types.

(iv) Identifying which unit is the primary in cases where a relationship is used (e.g. wireless access point and clients).

(v) Discovering loops in the topology and automatically shuts them down until the loop is corrected.

(vi) Defining the type of device connected to a slave unit (e.g., a set-top box, or a computer. This information may be used to prioritize traffic, or to put traffic onto different virtual local area networks (VLANs).

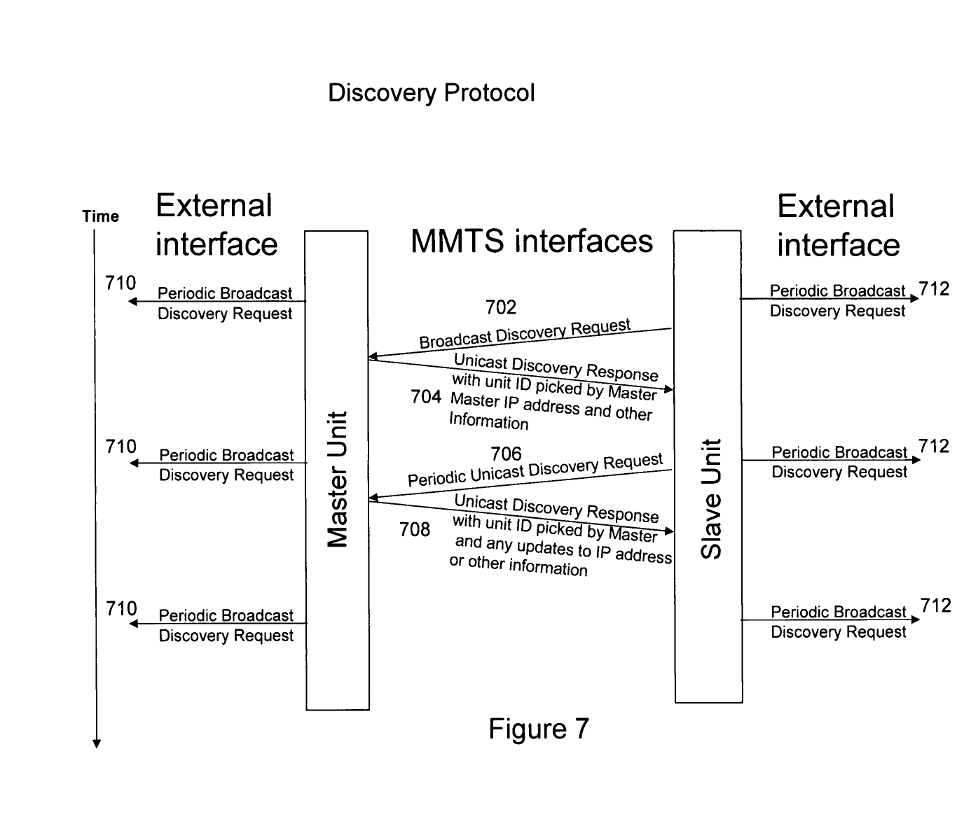

In one embodiment, the Base MAC address for the unit is sent in the discovery packets as a unique identifier and kept track of by all receiving units. A smaller byte sized value is assigned by the primary unit and used in other types of protocol packets where the peer identification is required. This allows for quick indexing to find data structures associated with the peer. FIG. 7 shows discovery packet passing in accordance with an embodiment of the invention when using a primary and slave implementation as would be done for shared media (e.g., wireless communication). In this implementation example, slave units initially send a broadcast discovery request out all the MMTS interfaces (702). The primary unit sends a unicast response to the sender of the packet broadcast discovery back out the physical interface the broadcast discovery packet was received (704). When the slave unit receives the response, it now knows the primary to talk to and if the interface is available for MMTS traffic. The slave continues to send periodic unicast discovery packets directed to the primary out each MMTS interface (706) (once every few seconds) and the primary will continue to respond (708). The discovery packets can be used to pass other information such as the IP address, subnet mask etc of the units. The discovery request packets are periodically sent out the Non-MMTS interfaces by the primary (710) and slave (712). Should one of these packets be received by the primary or slave, then a topology loop exists and one of the units must stop forwarding traffic. A simple algorithm for determining which device would stop forwarding is as follows. If a slave receives a discovery packet on the Non-MMTS interface from a primary, then the slave stops forwarding traffic. (The primary would ignore discovery packets from slave units on the non-MMTS in this case.) If a slave receives a discovery packet on the Non-MMTS interface from another slave, then the slave with the smaller MAC address stops forwarding traffic, and the slave with the larger MAC address continues to forward traffic. Likewise, if a primary receives a discovery packet on the Non-MMTS interface from another primary, then the primary with the smaller MAC address stops forwarding traffic, and the primary with the larger MAC address continues to forward traffic. (Other algorithms may, of course, be used.)

### Latency and Bandwidth Measurement Between Peer Units

In many shared topologies the latency and bandwidth may vary from peer to peer. In such cases, information on latency and bandwidth related parameters is required for load balancing traffic between the units. In one embodiment, as discussed below, this information may conveyed via ACK packets and “LINK packets” (discussed in detail below) which utilize the peer unique ID distributed with the discovery packet.

### Flow Creation (Flow Initiation)

When a packet is received on a non-MMTS interface that is destined for a destination connected to another MMTS interface, a special packet (a flow creation or initiation packet) may be used to establish the transmit flow. This packet is an acknowledged packet. In other words, a response (ACK) packet is sent upon the reception of this packet. If a response is not received, then the flow creation packet may be retransmitted to make it reliable. The flow creation packet contains identification of the sending unit, and the associated response packet contains identification of the receiving unit. In other words, the sender of the flow initiation packet identifies itself in this packet so that the receive side will know to whom to send ACK packets. Likewise, the acknowledgement of this packet identifies its sender so that the transmitter of the traffic knows which MMTS unit (or MMTS units in the case of a broadcast) it needs to monitor for load balancing the flow. Such identification may be utilized to establish flows which require a broadcast, such as unknown unicast destinations, broadcast destination and multicast destinations.

The flow creation packets may provide the following functionalities (some of which may be optional):
(i) Creating a transmit flow when a new data stream is received from outside the MMTS network.
(ii) Creating a receive flow inside the MMTS network upon reception of the flow creation packet.
(iii) Resetting a specific peer when that peer has fallen too far behind. This may be particularly useful when one or more members of a multicast group have fallen behind.
(iv) Instructing a peer to drop the flow, for example, in the case when the source and destination are on the same physical port outside the MMTS network.
(v) On reception of an acknowledgement, inserting those members of the MMTS network that have joined a multicast flow.
(vi) Instructing a receiver as to where the sequence space is starting. This is advantageously useful, for example, for providing reliable multicast flows.
VII The response packet may also indicate the initial credit for the flow
(viii) May include information as to the type of flow (video, voice, and so forth) which may be used as a flow profile containing information, for example, to adjust the retransmission time, the time amount of buffering, priority levels, and the like. In some cases, no flow type information would be included, and the type of flow would not be known until a packet with a specific UDP or TCP port is passed.
(ix) May inform the receiver of the channels to listen on that are appropriate to receive the flow. (See aggregated bandwidth discussion below.)
(x) The flow creation packet (and acknowledgment) may also inform the receiver of these packets as to which unit the MAC and or IP address of the source of the flow is connected (and destination address in an acknowledgement). This information in turn is used in future flow creation packets to target that packet to the specific unit that is connected to the destination address rather than broadcasting to all units. Note that, in the primary-slave case, an unknown destination for a slave unit only goes to the primary unit; however, a primary unit may not know the destination ahead of time and may initially create a flow to all slave units until it has found the location of the destination unit for unicast flows. This would be analogous to the way an Ethernet switch treats an unknown destination address as a broadcast until it learns the port that the destination resides on. When an address has changed location, then flows associated with that address as both a source and destination are removed and then reestablished to the correct locations.

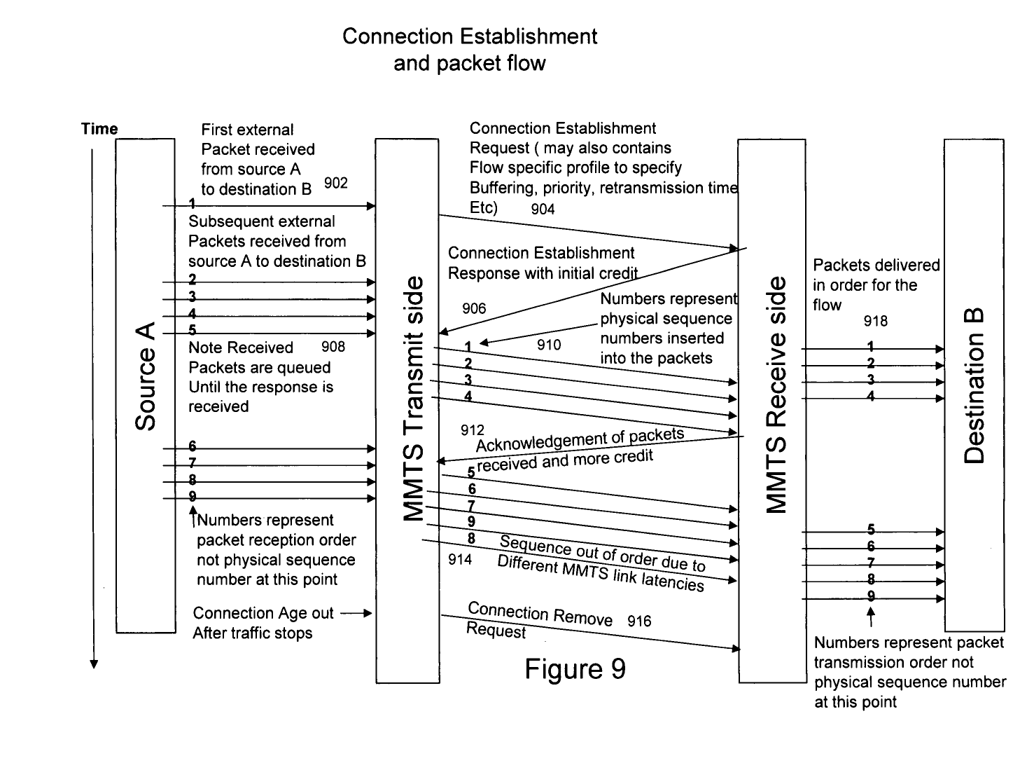

FIG. 9 shows the sequence for flow establishment and data passing when a packet is received from outside the MMTS network for a new source/destination pair. When an external packet is received (902), a connection establishment packet is set to the peer MMTS unit that contains the target for the destination (or to all peers in the case of broadcast or unknown destinations) (904). Packets received for the flow are queued (908) until the connection response is received. The response packet (906) completes the connection and passes the initial credit to the transmitter at which point data is allowed to flow. (The response packet may also inform the transmitter of the location of a specific destination if the MMTS unit knows that it is directly connected to that destination.) Sequence numbers are added to the packets in the order in which they were received. Acknowledgements periodically pass new credit (triggered by the need to pass more credit or a timer which ever comes first) and indicate the largest in sequence packet received (912). The sequence numbering allows the receiver to re-order packets that may have arrived out of sequence (possibly due to the different latency of the MTTS links) before forwarding the traffic (914). When traffic has stopped the transmitter will timeout the connection and inform the receiver(s) that the connection has ended in order to release system resources that are no longer needed for the flow. (916) Note: The connection release is not acknowledged since the receiver will eventually time out the connection if no data is received. (The connection remove is merely a mechanism to return resources used on the receive side back to the system sooner.) The connection release may also be used to terminate connections should the external port go down or if the source has moved to a different MMTS unit or when an unknown unicast destination packet has been learned and the initial broadcasting of the packet to all MMTS units is no longer necessary. All packets are transmitted to the destination in order (918).

### Multicast Flow Communication

Although in some cases multicast flows may be treated as broadcasts, in many cases a multicast flow is only passed if multicast join protocol, such as an IGMP join (also called IGMP report message) allow it. The transport may snoop on these joins to learn with unit or units require a multicast flow. This information is then used to keep track of which systems will need to ACK the multicast flow to ensure reliable multicast delivery to all appropriate units. If one peer does not acknowledge the packet, then the data packet is retransmitted. Those peers that have already seen the packet will ignore it in the case of a shared media such as a wireless LAN. Likewise when an IGMP leave occurs it will be removed from the list of remote units that an ACK is expected from. In a shared media those units who have not joined the flow will ignore the multicast traffic. If the flow is already established then this new join will add the new requesting unit into the flow. A bit map of all MMTS units joined to the flow is kept in the flow structure. This is used as a fast way to check which units have sent ACKs for packets that have been transmitted. For reliable multicast traffic each unit receiving the flow must acknowledge the reception of multicast traffic (typically one ACK for every 10-20 packets sent). The bit map is kept manageable by using the unique number negotiated with the discovery packets (e.g. if 16-remote units are supported the primary will assign numbers 0-15 to the remote units). This number is used for both bit maps and as an index to quickly determine the identity of a packet sent by a MMTS unit.

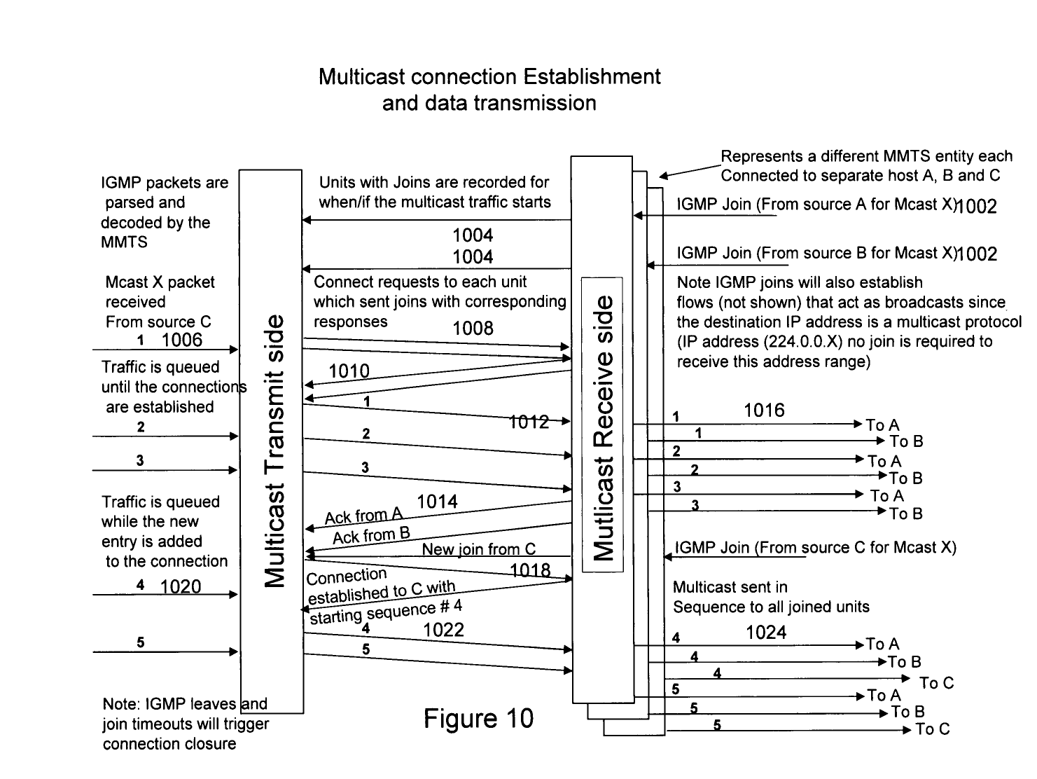

FIG. 10 shows the sequence for flow establishment and data passing for multicast traffic. When an IGMP join is received before multicast traffic (1002) the IGMP join is recorded by the receivers of the join (1004). This would typically include all MMTS units including the one that the joins arrived on from outside the MMTS network. These joins will themselves trigger the formation of a new broadcast connection to all units. (Note: In a primary/slave type implementation when a primary unit receives a broadcast connection it in turn would create transmit flows to all slave units other than the one that created the original broadcast, while the slave unit would only create a connection to its primary unit.) When multicast traffic does arrive (1006), a new connection would be established to each unit that had done a join via a connection request (1008) and response (1010). When all the connection requests have been acknowledged any multicast traffic that was queued for the connection would flow (1012). Sequence numbers are added to the packets in the order in which they where received. Acknowledgements periodically pass new credit (triggered by the need to pass more credit or a timer which ever comes first) and indicate the largest in sequence packet received (1014). The sequence numbering allows the receiver to re-order packets that may have arrived out of sequence (possibly due to the different latency of the MTTS links) before forwarding the traffic (1016). When a new join occurs when a connection has already been established, a new entry is added to the connection and a connect request is sent (1018) to tell the new joiner the sequence number to start using. (Note: traffic will be momentarily stopped to all units while this new unit is added, any traffic that arrives during that period will be queued (1020). Once the new entry is added via the connect response traffic will again follow (1022) with all joined units forwarding the traffic in order (1024). As units do an IGMP leave or the join times out a connect release will be sent to the units that have done the leave and or whose joins have timed out. If the multicast traffic stops for an extended period then the connection to all units would be closed. (Note: the IGMP joins may continue to exist so that the flows can be immediately re-established should the multicast traffic start up again.) As with unicasts, the flows are defined by source destination pairs, so multiple sources from different machines may generate traffic destined to same multicast address and each could set up multiple connections to all units that have done joins.

### Latency Factors

In order to load balance effectively, the latency across each physical “trunk” link (i.e. across each physical link-layer link) between all the MMTS peers is determined. In the case of a primary unit, the latency is determined between the and each slave/client on all the physical links.

In the case of physical links where the latency may dynamically change in real time, this latency information should be continuously updated. Latency is important here since the round trip latency across any given link should not be greater than the retransmission time. Latency is a function of the link rate (bandwidth), buffering along the route, and signal propagation time.

For the purposes of this discussion, assume that the signal propagation time for the physical links is generally very short (i.e. as in a local area network). In these cases where the propagation time for the physical links is generally very short, load balancing using latency works well.

In cases where this is not true and the physical links have high speed (e.g., satellite links), the sequence space used may be needed to increased so that large credits may be given out. In this situation bandwidth may be more effective in calculating load balance ratios and requires large amounts of buffering and long retransmission times. Large credits are required here in order not to leave the link idle for extended periods. Such extended idle periods would result in greatly reduced bandwidth utilization.

### Latency Measurements

When the media data rate and buffering is symmetric (i.e. same bandwidth and buffering in both directions), the latency may be determined from the round trip delay for the total bytes divided by two. In non-symmetric situations, other divisors can be used if speed and buffering ratios are known or measure-able, or reported by the hardware.

To get continuous updates on latency, the MMTS network passes back latency information on all physical links in the MMTS “trunk” via acknowledgement packets. Acknowledgement packets are sent out by the receiver to acknowledge the receipt of packet and to pass new credit to the transmitter so that it can continue to send packets. The general concept here is that transmit side records the time that it sends each packet and the receive side records the time it receives each packet. When the receive side sends an ACK it notes in the ack packet the time that it has held on to the packet that it is sending an ACK for before sending the ack. (When multiple interfaces are used it also records the time of any unacked packets that where last received on each interface and time since the packet was received and this ACK is now being transmitted. When the transmitting side receives the ACK it can then calculate how long it took to send a packet on each interface by comparing the current time (ACK receive time) and original packet send time and subtract out the time that the receiver sat on the packet before sending the ACK. With the transmit time information and packet length it can calculate a link latency for each interface and continuously update that latency as ACK packets are received.

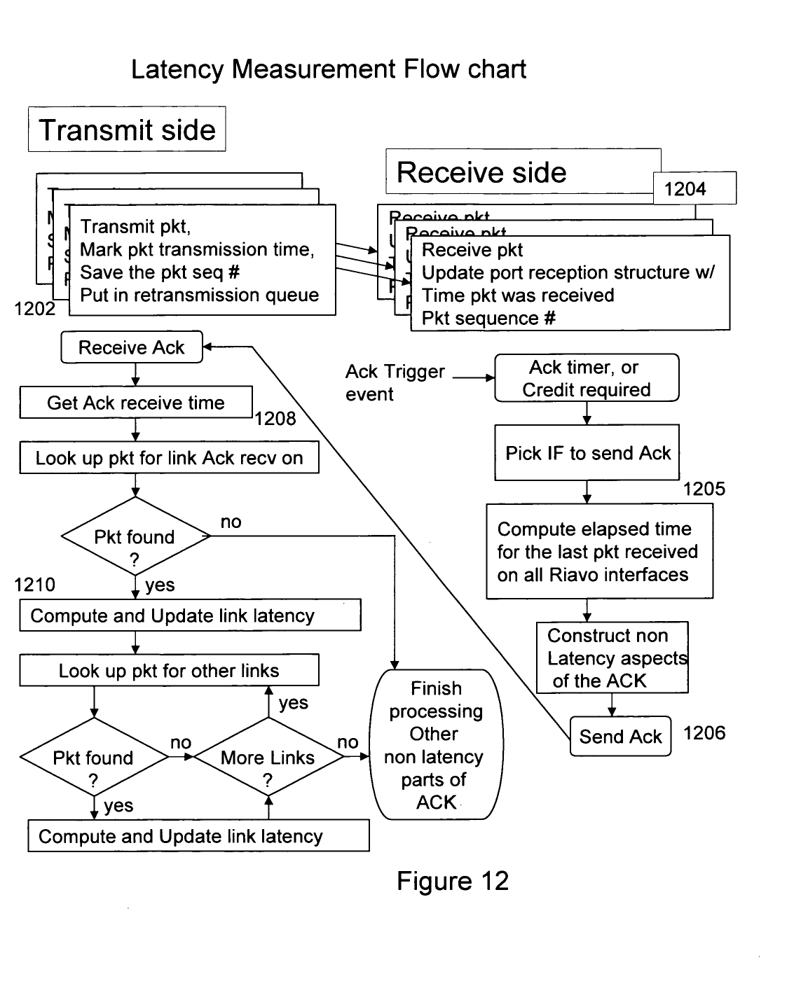

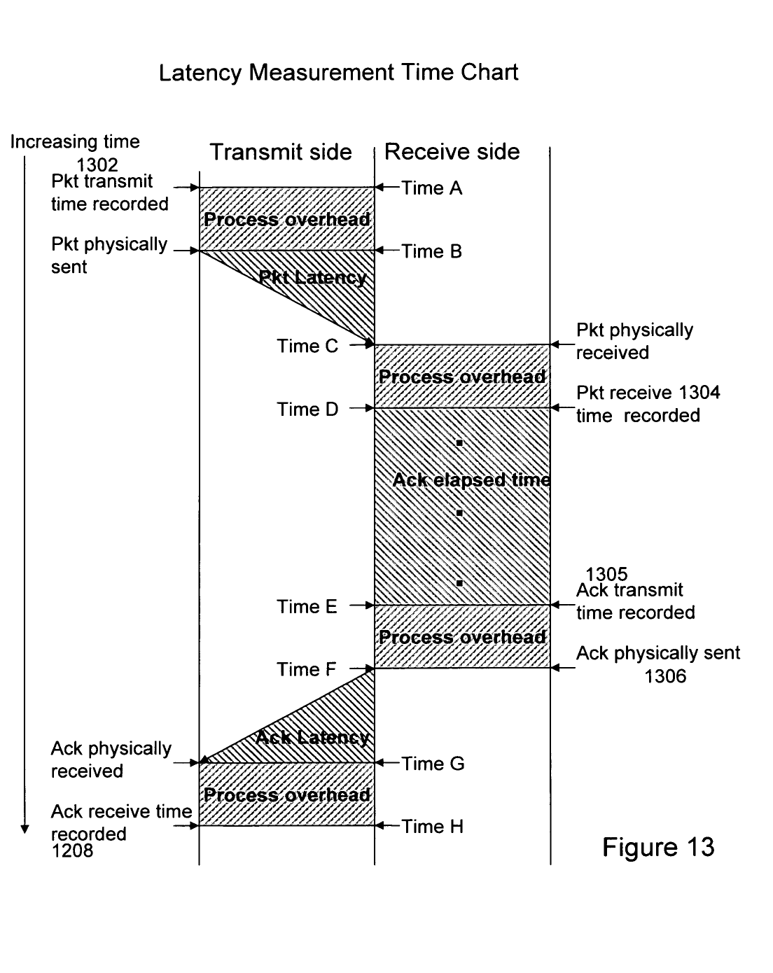

In accordance with one embodiment, the following procedure may be used to make this measurement. See the “Latency Measurement Flow Chart” in FIG. 12 and “Latency Measurement Time Chart” in FIG. 13.

(i) The transmitter timestamps each packet as it transmits it. It also keeps track of the packet sequence numbers and physical link the packets are sent out on while they are in a retransmission queue waiting for acknowledgement. (See “Mark pkt transmission time” in block 1202 of FIG. 13 and “Pkt transmit time recorded” 1302 at Time A in FIG. 13.)

(ii) The receiver timestamps when it receives a packet for each link (see “Time pkt was received” in block 1204 of FIG. 12 and “Pkt receive time recorded” 1304 at Time D in FIG. 13) and keeps track of the last sequence number and time stamp for each MMTS link.

(iii) When the receiver issues an acknowledgement (see “Send Ack” 1206 in FIG. 12 and “Ack physically sent” 1306 in FIG. 13) (typically when it needs to send more credit or when its Ack timer pops), it calculates the amount of time that has elapsed since it received a packet on each MMTS interface (see “Compute elapsed time for the last pkt received on all Riavo interfaces” 1205 in FIG. 12 and “Ack transmit time recorded” 1305 at Time E in FIG. 13) and will return this time along with the associated sequence number of the packet for each interface.

(iv) The transmitter records the time it received the ACK packet. (See “Get Ack receive time” 1208 in FIG. 12 and “Ack receive time recorded” 1308 at Time H in FIG. 13.)

It now calculates the latency for the link on which the Ack was received (see “Compute and Update link latency” 1210 in FIG. 5) using the information in the ACK packet for the packet that was last sent out this link.

The following description of the latency calculation refers to the times indicated in FIG. 13 (See Times A through H in “Latency Measurement Time Chart”).
The transmitter looks up the transmission time (Time A) for the packet whose sequence is noted in the Ack as being the packet that was last received on the link the Ack was received on.
It takes the difference between the packet transmission time and the Ack receive time. (Time H−Time A).
It then subtracts the Ack elapsed time for this packet returned in the Ack elapsed time. (Time E−Time D).
It then subtracts the process overhead. Process overhead=(Time B−Time A)+(Time D−Time C)+(Time E−Time F)+(Time H−Time G). These times should be fairly constant and small. Note that, in general, the implementer may want these values measured as close to the hardware reception and transmission as possible to keep the values very small. In most cases, a single time constant can be used for the sum of the process overhead points.
The time is then divided by the sum of the number of bytes in the packet plus the number of bytes in the Ack packet. This results in the latency per byte.

The above calculation assumes symmetric latency in both directions on the link. However, if the data packets are large compared to an Ack packet, any difference in latency will favor the latency in packet transmit direction which is what we are really after. In cases where latency is not very symmetric, the implementation may preferentially use large packets in the Ack information returned so long as the packets referred to in the Ack have not being previously Acked. Using non-Acked packets insures that the transmitter still has timing information on the packets since they will still be in its retransmission queue. In extreme cases it may also be possible to pass the receivers estimate of the link latency (This estimate may come from either bi-directional traffic or from link packet measurements). Using the receiver's estimate of link latency may give the transmitter a better idea of how much to account for the Ack latency.

Since the Ack also contains elapsed time information for physical links on which the Ack was not received on, we can calculate the latency on these links as well. However, for these links, we need to subtract the latency for the Ack packet since the Ack latency is only for the link the Ack came in on. We therefore use the following procedure to get the link latency on links other the link the Ack came in on.
The transmitter looks up the transmission time (Time A) for the packet whose sequence is noted in the Ack as being the packet that was last received on the link the Ack was received on.
It takes the difference between the packet transmission time and the Ack receive time. (Time H−Time A).
It then subtracts the Ack elapsed time for this packet returned in the Ack Elapsed time=(Time E−Time D). Note that this elapsed time is specific to this packet and different than the Ack elapsed time computed above.
It then subtracts the process over head (Process overhead=(Time B−Time A)+(Time D−Time C)+(Time E−Time F)+(Time H−Time G).
It then subtracts the Ack latency for the link that the Ack came in on. (i.e. subtract the latency/bytes (as computed for the link the Ack came in on) multiplied by the size of the Ack.
The time left is then divided by the number of bytes in the packet. This results in the latency per byte.

Note that, in some cases, no new packets may be received on either one or more of the physical links between ACK intervals. (This is also true at startup.) In this case, the transmitter will have already received acknowledgement for the packets and have freed them. Therefore, no new latency is computed for those links. The ACK packets are still sent, however, with the updated elapsed time so that if a previous ACK has been lost, the transmitter may still use the data to calculate latency. However, if no new packets have been received for an extended period, then the information should not be used as there is a danger that the sequence space could wrap causing a bad latency to be calculated. The receiver (Ack sender) may mark when the latency information is not be used. This may be done via flags in the ACK packet or by using an illegal sequence number for the link for which information is not valid (e.g., 32768 for a 15-bit sequence space size). The transmitter may also check that a packet referred to in the Ack for latency has not been retransmitted, as this could give a bad latency. Since the link the Ack came in on contains the information that is used to estimate the link latency on all the physical links, the receiver should try to send the Ack out on a link for which it has valid latency information.

When no data is flowing, acknowledgement packets have no latency data to measure; however, up-to-date latency information on the MMTS link is still kept so that load balancing ratios are correct when data does start to flow. This may be done by periodically sending a protocol packet on each MMTS link (e.g. once every few seconds) and reflecting it immediately back to the transmitter for each pair of intercommunicating devices.

In this case, only the transmitter needs to mark the transmission and receive times of these link-latency-determination packets or “Link packets” to determine the link latency. This is because very little delay should occur between the reception of the Link packet and the return of the acknowledgement. To further reduce the error in the measurement, the Link and Link Acknowledgement packets may be sent as maximum size packets to increase the proportion of time measurement that is due to the link latency and buffering and/or a “fudge factor” may be added in to account for system processing time. The periodic sending of these “Link packets” may also be used as a form of “keep-alive” detection to determine when a given link is unavailable between a given set of units. This may be done, for example, via a status flag in the packet, or by setting the Latency to a very large value, and or a timeout on reception of a Link acknowledgement.

### Load Balancing

The section above discussed how to measure the latency on the different MMTS interfaces. This latency is then used to generate a transmission ratio that determines the number of packets to send on each physical link. For example, in a simple two “trunked” physical link scenario, a ratio for 5-to-3 would indicate that for every 5 packets transmitted out of link 1, we send 3 packets out link 2.

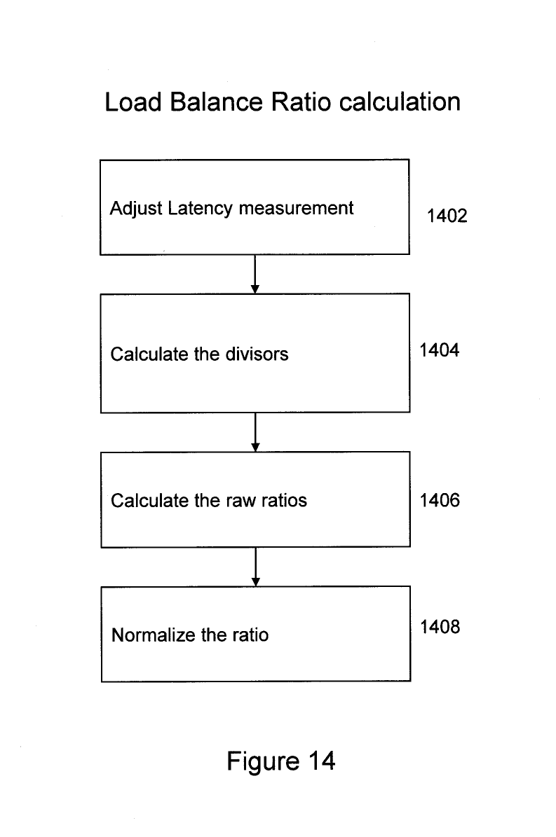

The following procedural description refers to FIG. 14. Since the latency measurement is always a bit behind in time, we preferably do not just take a ratio of latency on link 1 to latency on link 2 to generate the transmission ratio. Instead, it is desirable to look at the slope of the latencies on each link and adjust the latencies depending on the rate of change and direction of change. (1402) The adjusted ratios may then be used to calculate the transmission ratio. The tuning parameters for the ratios may be set differently on a per link basis to accommodate characteristic specific to the physical link type.

In general the following rules may be used. If the previous latency was less than the current latency (link slowing, down), amplify the effect of the change to prevent over loading the link. If the previous latency is greater than the current latency (link is speeding up), we tend to average in the new latency with the old to moderate the change and slowly approach the new latency to prevent overload.

The above rules provide an anticipatory link change based on the current trend and may be weighted appropriately to the links physical characteristics (e.g., how long a link type suffers from a noise spike and how quickly it recovers).

The following algorithms are examples of how this may be implemented. Note that other amplifying or moderating algorithms may be used depending on the characteristics of the media. Furthermore, these values will typically need some tuning based on the hardware being used. Although this example is for two links, many more links may be included in an implementation of the transport.

Increasing latency adjustment examples:

### EXAMPLE

### Linear Increase

// if latency is trending up then increase it.

if(new_latency > previous_latency)

{
// Here is a simple linear increase, where the
difference is taken between the
// the new latency (i.e. the measured latency)
and the previous latency, and the
// difference is added to adjust the new latency.
// Algebraically this is :
// measured_latency + (measured_latency −
previous_latency) =
// new_latency

new_latency += (new_latency −
previous_latency);
}

Similarly a linear decrease can be done
if(new_latency < previous_latency)

{

new_latency −= (previous_latency −new_latency
);
}

### Example

### Exponential Increase

// Here is an example of an exponential increase. We use
the ratio of the
// new_latency (i.e. the measured latency) to the
previous_latency to create a
// multiplier. Since integer arithmetic is assumed, if
new_latency is less than or equal
// to previous_latency, the −1 assures us that the ratio
will be 0 and, hence, the 1
// will not be shifted over and no change will occur to the
new_latency. If
// new_latency is greater than previous_latency, then the
ratio will be 1 or
// greater, and the numeric 1 will be shifted over by the
integer ratio. Shifting the
// 1 over by 1 effectively makes the value 2, shifting by
2 makes the value 4
// etc.) This value is then used as a factor to adjust the
new_latency, forming an
// exponential increase.
// algebraically this is:
// (2 to the power ((measured_latency−1)/previous_latency)
) × measured_latency =
// new_latency. Where the power can only be an integer value
0,1,2 etc.
new_latency = new_latency * (1<<((
new_latency−1)/previous_latency));

The above algorithm will leave the new latency untouched if it is less then or equal to the previous latency. If the latency is increasing then it is rapidly increased and then smoothed to prevent wild swings

// smoothing factor:
// Here is an example of a smoothing method. Here, again, we
assume integer
// arithmetic for high speed calculation. This method shifts
the previous_latency by
// 3 to multiply it by 8 and subtracts the previous latency
to effectively result in a
// fast multiple by 7. It then adds the measured_latency to
the result and then
// divides the entire amount by 8 (right shift 3). This makes
the new value in effect
// ⅛ of the entire value on each new measurement
and thereby dampens the rate
// of change.
// Algebraically this is:
// ( (previous_latency × 7) + measured_latency )/8 =
new_latency
new_latency = (((previous_latency <<3) −
previous_latency) +
new_latency)>>3;

The above algorithm averages in latency so that each new value accounts for ⅛ of all the previously measured values. Note: the above algorithm may be changed by using different values for the shift factor and is in fact a configuration value in a current implementation for each type of smoothing done.

Once the latencies have been adjusted, the ratios may be calculated. When calculating ratios, another factor taken into account is how close the latency is approaching to the retransmission time. If the latency is far from the retransmission time, then no additional modification is done. On the other hand, if the value is approaching the retransmission time, then the latency used in the ratio is modified to reduce the utilization of the link that is slowing. One method to do this is to calculate a divisor that is adjusted as the latency approaches the retransmission time (1404). This divisor is then used to calculate raw ratios (1406). Detailed methods for implementing these calculations are described in the following paragraphs.

The following example algorithm incorporates how close the latency of a given link gets to the retransmission time into the transmission ratio that is used to determine how packets will be divided between two physical “trunked” links. Of course, this algorithm may be extended to incorporate more than two “trunked” links. In this example, lat1 is the latency measured on link 1, and lat2 is the latency measured on link 2. MAX_LATENCY is based on the retransmission time for a maximum sized packet (e.g. 100 ms retransmission time with a 1500 byte packet MAX_LATENCY=˜66000 nanosec/byte). The value new_ratio1 indicates how many packets to send on “trunked” link 1 vs. new_ratio2 indicating the number of packets to send on “trunked” link 2. These values are used as counters. When a packet is sent on link 1, the appropriate counter is decremented. Once the counter hits zero, no more packets are sent out the associated link until both counters hit zero, in which case both counters are reset to the current ratios determined by new_ratio1 and new_ratio2.

// Get the sum of the latency and amplify the value to
// generate reasonable ratios since integers don't have
// fractions. A reasonable value for MAX_RATION_FACTOR is
// 7 so that we effectively are multiplying the sum of
// lat1 and lat2 by 128.
sum = (lat1 + lat2) << MAX_RATIO_FACTOR;
// Create values to use when latency gets larger than MAX
// latency to prevent divide by 0 and negative values.
// (i.e. trim_lat1 and trim_lat2 are always less than
// MAX_LATENCY
if( lat1 >= MAX_LATENCY )

{
trim_lat1 = MAX_LATENCY−1;
}

else

{
trim_lat1 = lat1;
}

if( lat2 >= MAX_LATENCY)

{
trim_lat2= MAX_LATENCY−1;
}

else

{
trim_lat2 = lat2;
}

// Note the dividing factor that comes into play when one
// of the latency value gets close to MAX latency. Max
// latency is typically a function of the retransmission
// value.
divisor1 = MAX_LATENCY/(MAX_LATENCY − trim_lat1);
divisor2 = MAX_LATENCY/(MAX_LATENCY − trim_lat2);
// Divide down the ratios and prevent 0.
// If both latencies are about the same and not close
// to MAX_LATENCY, then this will return a ratio of
// 33 to 33 using a MAX_RATIO_FACTOR of 7.
new_ratio1 = (((sum/lat1) >> 3)/divisor1) +1;
new_ratio2 = (((sum/lat2) >> 3)/divisor2) +1;
// Limit the ratio to some reasonable number.
// The typical ratios will go between 1 and 128 using
// this Algorithm with MAX_RATIO set to 128 and a
// MAX_RATIO_FACTOR of 7
if( new_ratio1 >MAX_RATIO )

{
new_ratio1 = MAX_RATIO;
}

if( new_ratio2 >MAX_RATIO )

{
new_ratio2 = MAX_RATIO;
}

}

}

In a preferred embodiment of the protocol, the way the links are chosen using the latency-based ratios should “divided down” so that packets round robin though the links as quickly as possible (1408). For example, in a three link scenario where a ratio of 68:45:17 was determined on the first, second and third links (link 1, link 2, and link 3, respectively), the first link should not be used 68 times, the second 45 times and the third 17 times. Instead, the first link may be used 4 times, the second link used 2 times, and the third link used 1 time. This approximation will round robin through the links more fairly. If the ratio has not been updated before 17 packets have been sent out link 3, then link 2 should be used first on the next round of transmission since it was not fully utilized in the round robin sequence. This is because 4*17=68 so link 1 was fully utilized, 2*17=34 so link 2 was not fully utilized, and 1*17 link 3 was fully utilized. In general, with dynamic links, the ratios will be constantly changing and the traffic should be initially sent out the lowest latency link (e.g., link 1 in this example). The algorithms will tend to self correct since a link that is getting over utilized will start increasing in latency and hence get a reduced number in the ratio, and links that are under utilized will start lowering in latency and get a higher ratio number.

### Bandwidth Measurement

With the ratios determined, the overall bandwidth of the links is preferably also found so that more traffic is not sent down the links than they can handle. In the ideal case, the hardware can inform the software of the current data rates, or at least indicate if the MAC layer has not finished with the previous send. In some cases, the hardware may not provide the necessary bandwidth information, or other devices may exist between the transmitter and receiver. In these cases, the bandwidth may be determined in more indirect ways.

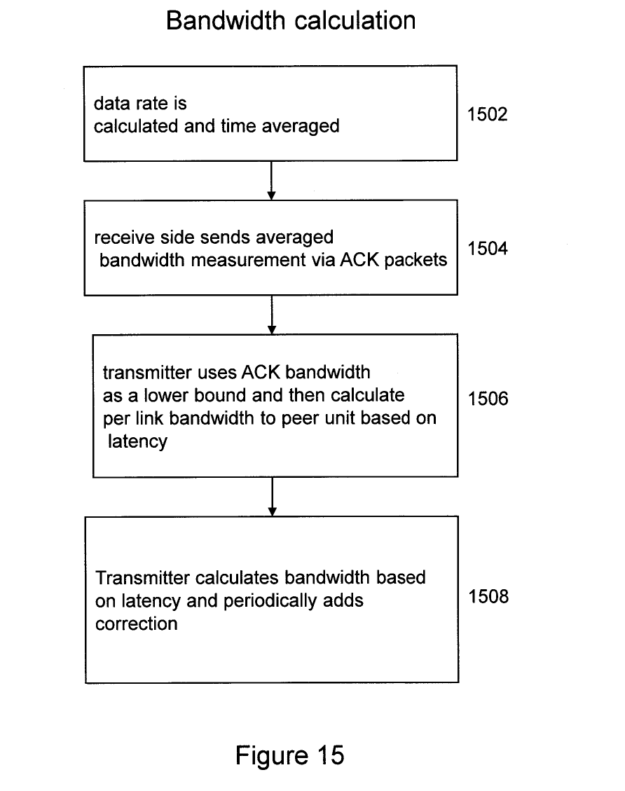

The following describes methods which can be used to gather the bandwidth information for use in the MMTS Transport (see FIG. 15)

To measure latency, the receiver was already time stamping packets received as discussed above. This measurement may now be leveraged in a couple of ways. First, the time between packets may now be found and used to calculate bandwidth over a period of time. The actual measurement of time between packets may vary due to system buffering and process scheduling. Therefore, it may be necessary to time average the bandwidth over multiple packets. Note that time stamping the packet as close to arrival as possible is best (i.e. down at the driver, or even in the hardware if specialized hardware is available for this purpose). The receiver continuously calculates bandwidth (1502) and sends out this information in the ACK packets (1504).

The following is an example of how the receiver may quickly time average in the bandwidth measurements. In the following, current_receive_time is the time when the current packet was received, previous_receive_time is the time when the previous packet was received, packet_len is the length in bytes of the current packet, new_byte_rate is the new weighted averaged bandwidth, old_byte_rate was the previous weighted average byte rate.

// take the difference between current time and previous packet receive
time.
time = current_receive_time − previous_receive_time;
//calculate byte rate
byte_rate = packet_len/ time;
// weight average the byte rate with the previous packets. Each new
packet
// adds 1/32 of the measured value.
new_byte_rate = ((old_byte_rate<<5 − old_byte_rate) +
byte_rate)>>5;

Every time an acknowledgement is sent, it may include this updated bandwidth. Note that this may be done on a per physical link basis which gives better information than an aggregate bandwidth. The per link bandwidth may vary from peer to peer depending on the media type, so keeping track of per link per peer bandwidth is useful as discussed in bandwidth usage under packet transmission below.

This measurement will give a lower bound to the current bandwidth when traffic is flowing since it says what made it through but not necessarily what is possible (1506). When no data is flowing, the latency may be used to estimate the bandwidth. However, its accuracy is only valid if the transmit time of the packets is very small and not much buffering occurs along the route. The latency value should give a reasonable starting point for bandwidth. With this information, the transmitter may slowly ratchet up bandwidth it allows until it starts to see retransmissions as such retransmissions would indicate that one or more of the links are being overloaded (1508). Note that if one link tends to get more re-transmissions than the other, then this would indicate that the transmission ratio is not quite correct and may need slight adjustment.

In some cases the hardware chipset may add information as to the bandwidth available. This information may periodically be incorporated into the measurements, and its weighting factor can be set based on the accuracy of the chip set. Note, in the case of multicast traffic, where multiple remote units are involved, then the bandwidth itself may be used to determine the ratio of traffic to send over the different ports. In this case, the worst bandwidth measured on each link to each participating unit can be used so as not to overload any given link in a shared media environment and reduce the overall retransmission rate.

### Packet Transmission

Now that we have latency measurements for the physical links and bandwidth between the peer units, we can send data between them. This section discusses the mechanisms used to queue and forward traffic out the MMTS interfaces in accordance with one embodiment.

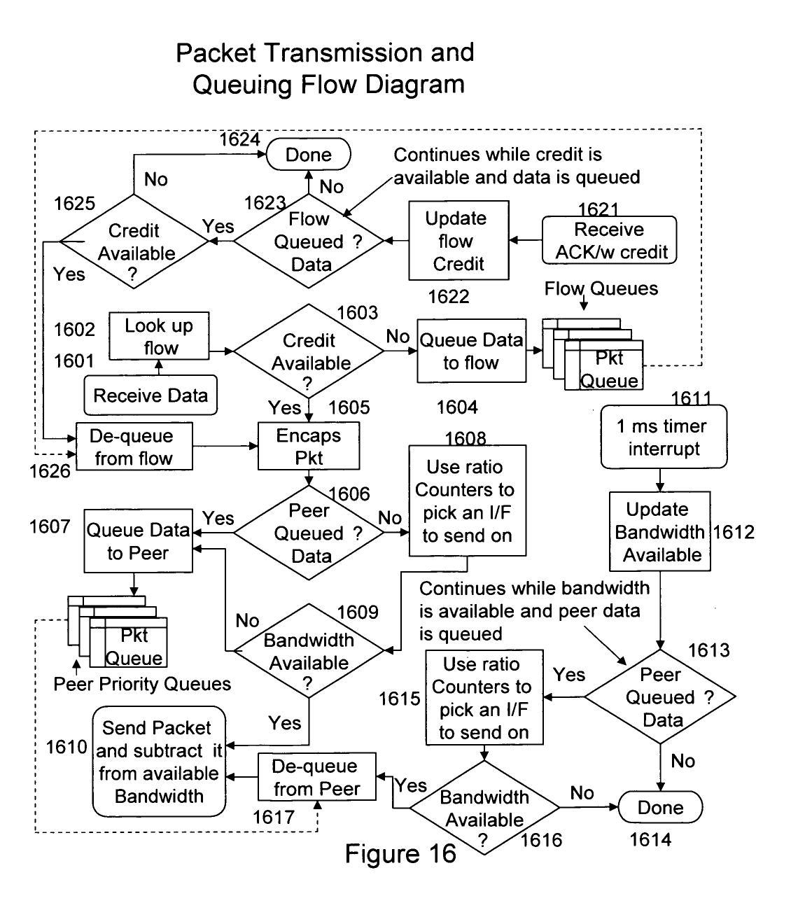

FIG. 16 is a flow diagram showing a method for packet transmission and queuing in accordance with one embodiment of the invention. As an overview, in this embodiment, there are two levels of queuing, an upper level and a lower level.

The upper level will queue packets based on credit available for the flow. This information comes from the Ack packets that indicate the next expected sequence number in the flow and the maximum sequence number allowed.

The lower level will queue packets based on bandwidth available on the different links. This bandwidth is determined by the mechanisms defined above. The bandwidth is used to calculate how many bytes a given link is allowed to be transmitted in a given timer interval. In one implementation, byte counters are incremented on each transmission and reception on a given link. These byte counters are then compared with the bandwidth allowed on the link for a given peer. A timer (for example, a 1 millisecond timer) is used to periodically reset the byte counters so as to form the timer intervals.

As packets arrive, a determination is made as to which flow (i.e. which source-destination address pair) these packets belong, credit is then checked. If no credit is available, the packets are queued in reception order without any modification. Note that the maximum size of this queue may be determined by flow characteristics so that different types of flows allows for more queuing. If credit is available, the packets are modified as described above and checks are made to see if packets with this priority and destined to the same peer MMTS unit are queued. If there are queued packets, then this newly arrived packet is queued to the end of the peer priority queue. If no packets are queued, then a check is made to see if bandwidth is available in this time interval. If no bandwidth is left, then the packets are queued to the head of the priority queue. If bandwidth is available, the packet is forward using the load balance ratio determined from latency. Every timer interval (e.g., every 1 milliseconds), a timer pops and resets counters used for bandwidth control. At this point, a check is made for packets queued to the peer priority queues, and traffic is forwarded out the links in priority order until either all peer queued packets have been sent or until no bandwidth remains. Note that other mechanisms other than strict priority may be used depending on the application needs.

The following bullets describe the specific actions illustrated in FIG. 16.

### Packet Reception

Receive data 1601 is analyzed 1602 to find the associated flow (or create a new flow). Determining the flow will typically also determine the peer, unless the destination is unknown. In the unknown destination address (DA) case, a default destination entry is used. The bandwidth and latency of the default destination address may be an average of all the actual peers for which the peer communication has been established. When
   relationship occurs (wireless access point to wireless clients), the s always just use the as the remote.
The flow is then checked 1603 for available credit.
If credit is not available, then the packet is queued 1604 to a flow specific queue in the order in which it was received and the process loop is done.
If credit is available, then the packet is encoded/encapsulated 1605 using, for example, one of the encapsulation methods discussed above.
A check is then made 1606 to see if data to this peer at the packets priority is currently queued. (Note: priority here may be set as another attribute of a given flow type, e.g. voice versus video.)
If packets at the same priority and peer are queued, then this new packet is queued 1607 to the tail of the peer priority queue and the process loop is done.
If packets with the same priority and peer are not currently queued, then an interface to be used is determined 1608 based on the latency ratio determined for the specific peer.
A check is then made 1609 to see if bandwidth is available on the interface.
If no bandwidth is available, then the packet is queued 1607 to the peer priority queue.
If bandwidth is available, then the packet is sent 1610 and put into the retransmission queue and a timer set. If this timer pops before an acknowledgement occurs that includes this packets sequence number, the packet is resent as a high priority packet and typically picks the alternate interface to be sent on.
The number of bytes transmitted in the packet is then added to the global bandwidth byte count for bandwidth utilization control and the process loop is done.

### Timer Bandwidth Replenish

Every 1 millisecond (or other timer interval), an interrupt occurs 1611 and triggers the update 1612 of available bandwidth based on the currently measured bandwidth. This resets the byte count for each link to each peer. (Note: bandwidth information is kept per physical link per peer.) This may also be adjusting down if a given link has had any retransmissions. Intelligence may be added to the latency ratio algorithm if retransmissions are chronically seen on a given physical port. A simple implementation may use an additional latency value that is added to the specific link during the latency calculation. If the retransmission rate goes up, the value is increased; if the retransmission rate goes down, the value is decreased. Note: when no retransmissions are occurring then this value will tend to zero. A check is then made 1613 to see if any packets are currently queued in any of the peer priority queues.
If all the peer priority queues are empty, then the process loop is done 1614.
For each peer priority queue that has queued packets, the following occurs with the highest priority queues first followed by the next lowest priority, etc.
   The latency ratio determined 1615 for the specific peer is used to pick an interface to send on.
   A check is then made 1616 to see if bandwidth is available on the interface.
   If no bandwidth is available, the next peer MMTS unit with queued packets is checked. (Note: different peer units may have different amounts of bandwidth available.)
   If bandwidth is available, then the packet is de-queued 1617 from the peer and sent 1610 and put into the retransmission queue and a timer set.
   The number of bytes transmitted in the packet is then added to the global bandwidth byte count for bandwidth utilization control (i.e. subtracted from available bandwidth).
   If more packets are queued the loop continues. For fairness the queues are scanned in priority order which each remote peer getting an equal opportunity to send data at a given priority. However, since some peers may have lower bandwidth they will be put at the head of the queue at the next time tick.

### Ack Reception

When an ACK arrives 1621, credit is updated 1622 for a given flow. (Note: Acks without credit only update latency and bandwidth and exit at this point.)
A check is then made 1623 to see if any packets are currently queued for this flow.
If no packets are queued for this flow, then the code is done 1624 and waits for the next event.
If packets are queued, then a check is then made 1625 to see if credit is available.
If no credit is available, then the code is done 1624 and waits for the next event.
While packets are queued and credit is available, the following occurs:
   If packets are queued for this flow, then credit is checked. (Note: the first time through the loop credit must be available since the ACK just sent it.)
   If there is credit, then a packet is removed 1626 from the flow queue.
   The packet is then encoded/encapsulated 1605 using, for example, one of the encapsulation methods discussed above.
   A check is then made 1606 to see if data to this peer at the packets priority is currently queued.
   If packets at the same priority and peer are queued, then this new packet is queued 1607 to the tail of the peer priority queue and the process loop goes back to check credit and the flow queue.
   If packets with the same priority and peer are not currently queued, then an interface is found 1608 to use based on the latency ratio determined for the specific peer.
   A check is then made 1609 to see if bandwidth is available on the interface
   If no bandwidth is available, then the packet is queued 1607 to peer priority queue
   If bandwidth is available, then the packet is sent 1610 and put into the retransmission queue and a timer set.
   The number of bytes transmitted in the packet is then added to the global bandwidth byte count for bandwidth utilization control (i.e. subtracted from available bandwidth).
   If more packets are queued to the flow queue and credit remains the loop is repeated.

As each packet is sent during a given time slice, the bandwidth for the link during the time slice is reduced. (In the one implementation, this is a global counter that increments up and is compared the link bandwidth of a given peer during the time slice.) As packets are sent to a given peer, that peer may have run out of bandwidth. However, another peer may still have bandwidth left, so if the current bandwidth count is exceed for one peer, the next peer is checked to see if bandwidth is left during the current time slice. (This decision is included as part of the bandwidth decision block in the diagram.) Note that in shared half duplex media environments, receive packets also subtract from the total bandwidth in a given time slice (increments the global per link bandwidth counter); therefore, all data is passed up to the transport even if the data is not from or to the MMTS unit. (This is not required in full duplex non-shared media such as switched Ethernet.)

For maximum bandwidth utilization, peers may be scanned based on their available bandwidth (smallest first); however, for fairness a round robin scheme may be more appropriate.

Packets of low priority may optionally be always queued even if bandwidth is currently available and hence delayed until the next timer bandwidth update. This then will prevent low priority packets from using any bandwidth in the current time period in which they arrive and reserves this bandwidth for higher priority packets that are about to arrive in the current time interval.

### Packet Retransmission

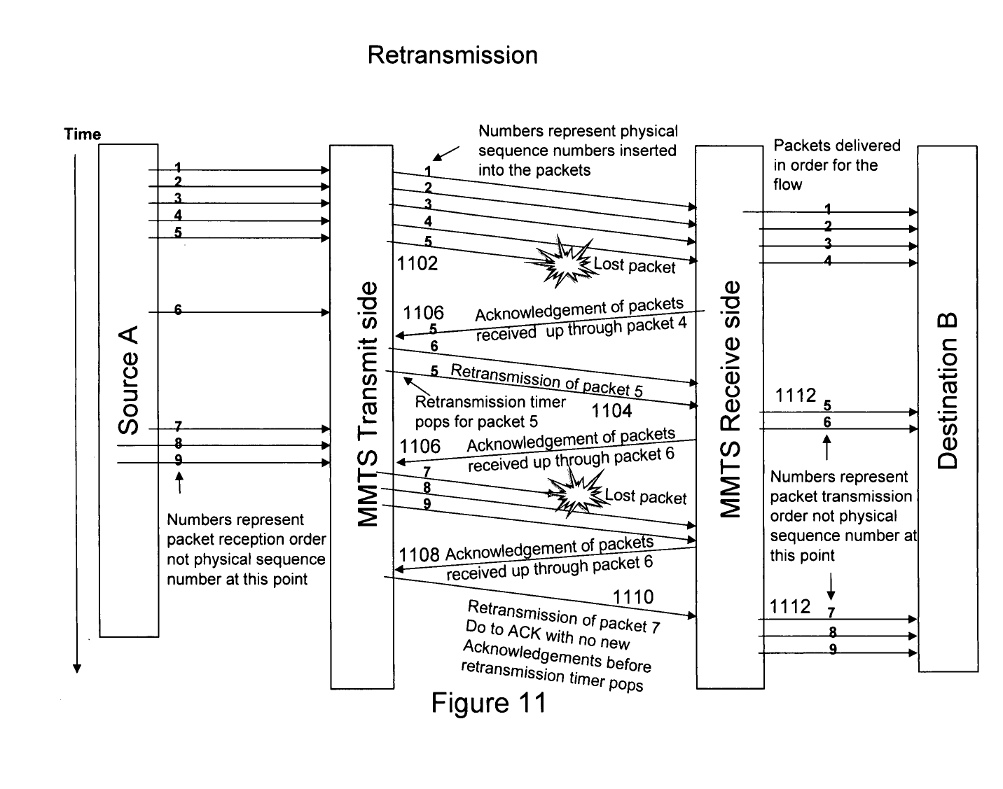

As the transmitter sends each packet, the packet is kept in a retransmission timer queue so that lost packets may be recognized, see (1102) in FIG. 11. If the packet is not acknowledged before the timer pops, the packet is resent (1104). The acknowledgement packets do not acknowledge each individual packet but rather the last received in sequence packet. The acknowledgement therefore typically acknowledges a group of packet (1106). Transmission of acknowledgements is determined by the amount of out standing credit and a timer. If, however, a packet is lost, the receiver will end up with a hole in the sequence, and the ACK sent via the timer mechanism will not acknowledge any new packets. If the transmitter is starting to queue packets due to lack of credit, and it receives an ACK with no new credit (1108), it can use this fact to retransmit the first unacknowledged packet before the retransmission timer for that packet pops (early retransmission) (1110). Since retransmitted packets may be holding up the forwarding of multiple packets on both the receive side (packets queued in the receiver but not forwarded due to not having all the packets in sequence) and transmit side (packets queued due to lack of credit), these packets are normally promoted up in priority to quickly free this log jam (1112). When the transmitter starts queuing too many packets, it may inform the peer to immediately give it the maximum credit available and to increase ACK frequency via the 16th bit in the sequence space reserved to flag overload conditions. Note that, in a preferred embodiment, the point at which overload occurs is somewhat higher than the point at which overload is considered corrected. This will allow some hysteresis to prevent continuously bouncing between an overload and non-overload condition. The receiver will slowly increase the rate of acknowledgements when it receives a packet with the overload bit set (up to a configured limit) and will slowly reduce it back down to a pre-defined level when the bit is not set. By increasing the rate of Acknowledgements when an overload occurs, more latency measurements are taken, which gives a better value for how to utilize the links and thereby reduce packet losses due to link overloading. This also more quickly triggers the early retransmission to recover from lost packets. A slight modification to this algorithm is to immediately send a duplicate ACK upon the reception of the first packet with the overload bit set.

For a multicast packet, the traffic queue waits for all the associated entities to send an acknowledgment. If any of the entities don't receive a packet in time, the transmitter will used the timer and early retransmission method to recover the packet. In a shared media type such as 802.11, those entities that have already acknowledged the packet will see the packet as duplicate and drop.

### Graceful Degradation

When bandwidth is limited, it is best to gracefully degrade performance rather than just fail. In one embodiment, the MMTS transport includes several mechanisms to provide this type of functionality.

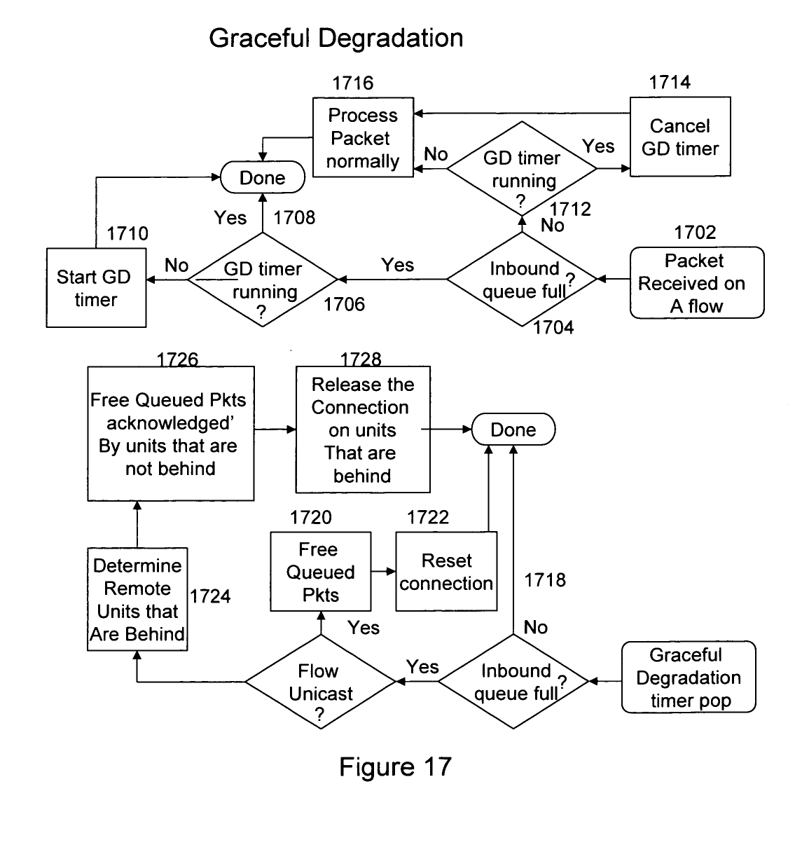

When too many retransmissions occur, extra bandwidth is required to send these retransmissions. However, if we are at the very edge of available bandwidth, a situation can occur where we are perpetually behind and never catch up. This will result in traffic backing up on the receive queue to the point where packets get dropped. (I.e. ACKs to give new credit have not occurred in time.) FIG. 17 illustrates how the graceful degradation timer (GD timer) is used to correct this. As new packets are received (1702) the inbound queue is checked (1704), if the queue is full then a check is made if the GD timer is running (1706). If the timer is running, then the GD check is done (1708), if the timer is not running then the GD timer is started (1710) and the sequence is done. If the flow inbound flow is not full, then a check is made to see if the GD timer is running (1712). If the timer is running then it is cancelled (1714). After it is cancelled or if it wasn't running the packet is processed normally (1716) and the sequence is done. If when that timer pops and the queue is not still full, then the timer is ignored (1718). For unicast flows if the queue is full then the connection is reset. This will drop packets currently in the retransmission queue (1720) and start the connection over (1722).

In some cases, an extended glitch in the media will force a backlog of packets but not necessarily to the point where the degradation timer has popped. This results in the same packet being sent multiple times. In this case, the connection is reset, and packets in the retransmission queue are quickly flushed. The number of retransmissions that trigger this event is configurable on a per flow type basis (e.g. fewer for voice longer for buffered video).

With multicast traffic where several receivers are listening and acknowledging the same multicast flow, the graceful degradation timer is also used. As in the case above, the timer is started when the receive queue is full. When the timer pops, those devices that are not keeping up with the flow are removed to allow those that are keeping up to receive uninterrupted traffic. In the multicast cast the system determines which remote units (slave units) are have fallen behind in packet acknowledgements (1724), and all packets that have been acknowledged by the those units that have kept up are now freed (1726), and the connection is released on those units that have not been keeping up (1728).

When a multicast flow has retransmitted a packet the maximum number times, then the unit (or units) that have not received the retransmitted packet is (are) reset. Those units that have been keeping up are not reset and will not end up with any drops.

### Table Aging

In the preferred embodiment of this transport, the flows, the IP address tables and MAC address tables all age out when not in use to recover system/memory resources. This may be a low priority task typically occurs over tens of seconds or even minute intervals. When no packets have been sent to or from a given IP address after a long interval, the address is removed, as well as any flows with which they are associated. If a given flow has not forwarded or received any traffic for an extended period, then it likewise is removed.

### Bandwidth Aggregation

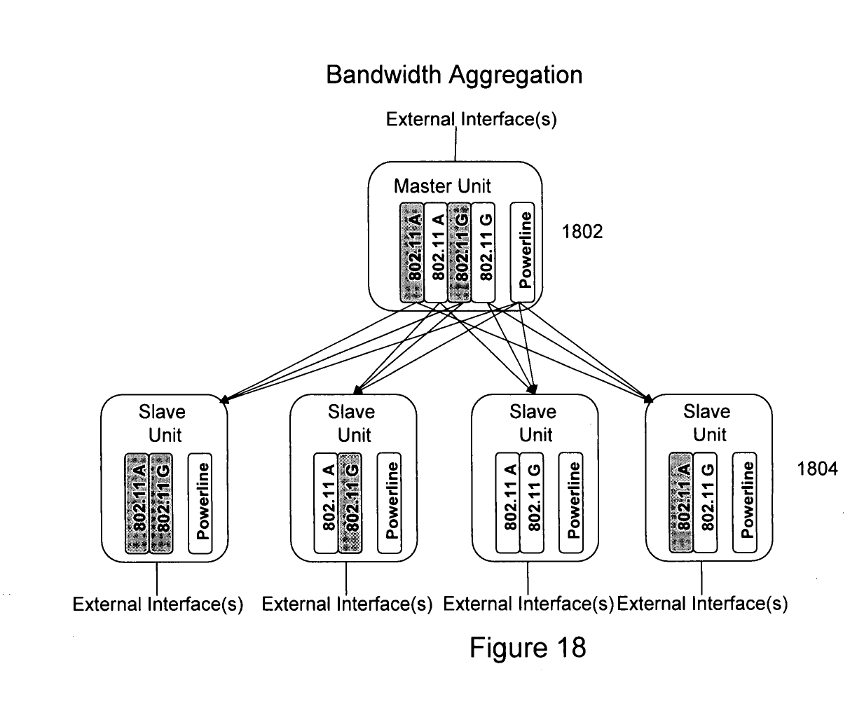

FIG. 18 illustrates bandwidth aggregation in accordance with an embodiment of the invention. For shared media environments where multiple channels are available, a primary unit (e.g., an access point) 1802 distributes traffic to slave units 1804 and may inform the slave units as to which channels are available. In these cases, it may not be necessary to deliver the full aggregated bandwidth to each slave unit. Therefore, receive channels can be defined for specific flows and that flow information may be passed to the slave unit who wishes to receive that flow. This reduces the cost of slave units while allowing scaling of the traffic up with extra channels.

For example, in an implementation of the MMTS, a slave unit may have the capability of listening to a single channel on 802.11A and 802.11G, while a primary unit may have multiple sets of 802.11A and 802.11G channels available. The primary unit may then not only load balance across multiple media types, but also across multiple sets of media types to deliver higher bandwidth in a very scalable way. As more total bandwidth is needed, more sets of A and G channels may be added. Note that this does not prohibit the use of other media types (e.g., Powerline) that do not have channels; however, this other media would typically need to be available in all the units if they all are allowed to simultaneously receive any specific flow. If all the slave units wish to receive the same flows, then all the units would be using the same channels, then aggregation is limited to only a common set of ports; however, even in this case, there is still the advantage of picking the best common channels to enhance reliability and bandwidth. In cases where different slave units listen to different flows, the full advantage of this technique may be realized. This may be common case when MMTS is used for video distribution in a home environment, where each slave unit is connected to a separate set-top box.

### Overview of Innovations Provided by MMTS

Transport that allows a packet flow for the same source-destination pair to be sent across multiple physical links which can dynamically vary in bandwidth and latency and ensures in-order reliable delivery of the packets. Allows aggregation of bandwidth, and insures in order delivery of packets of the same priority with in a flow.
Unique encoding scheme that allows transport information to be encoded into the packets without changing there size (avoids fragmentation).
Discovery Packets used to find peers to negotiate unique identifiers among the units.
Discovery Packets may also be used to determine loops in the topology and be used to break these loops.
Flow creation for unicast, broadcast and multicast reliable flows over non-reliable media.
Peer-to-Peer latency information encoded in the ACK packets to dynamically change load balance ratios for individual between peers.
Dynamic Bandwidth measurements that allow overall bandwidth to be determined and used to manage bandwidth between all the flows to any peers in either a round robin or priority order.
Priority mechanisms for packets within a flow.
Quick recovery of lost packets and dynamically alters behavior to effectively retransmit lost packets (early retransmissions).
Graceful degradation when links fail.
Bandwidth aggregation techniques at both the individual unit and overall network level.

In other words, the above-described multilink meshed transport service may advantageously provide the following capabilities:

First, the MMTS protocol encodes information into packets transmitted so that they may be kept in the order in which they were received. This advantageously allows packets for a single source-destination pair to be sent out of multiple link-layer links, rather than being limited to a single link as in conventional network trunking.

Second, this transport protocol advantageously recognizes when packets are lost and will retransmit them as necessary to provide a highly reliable connection.

Third, the MMTS protocol discovers all devices participating in the multilink meshed topology so that it can recognize which devices should acknowledge the receipt of specific packet flows. This advantageously allows the protocol to work in meshed topologies with shared media such as wireless, HomePlug, and so on.

Fourth, this transport protocol continuously (or nearly continuously) measures latency between the participating units so that traffic may be load balanced in real time. This advantageously allows using physical links that can dynamically change bandwidth to be aggregated in the mesh.

Fifth, this transport protocol continuously (or nearly continuously) estimates bandwidth available on the different links to prevent traffic loss when sending high volumes of traffic.

Sixth, the MMTS protocol allows for methods to prioritize different traffic types.

Seventh, the MMTS protocol advantageously provides added bandwidth capabilities by aggregating the bandwidth of all the meshed links.

Eighth, this transport protocol provides added security since tapping into any one link will not allow an intruder to capture all the packets of any flow. This is because a single flow is generally spread out over multiple links.

Ninth, the protocol packets used for this transport may be provided with an authentication field in their header that will prevent counterfeit packets from damaging the flows, as well as sequence numbers to prevent replay of previously recorded packets from causing issues.

Tenth, this transport protocol should be extremely useful for video distribution and could built in to Set-Top boxes, TV's, DVD players, Media servers, digitial video recorders and so on.

### CONCLUSION

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of transporting data packets between a plurality of transport units, the method comprising:
creating transmit flows which are associated with a source-destination address pair for new data streams received from outside a network of the transport units;
providing a separate sequence space for each transmit flow; and
spreading the transmission of the data packets belonging to a same transmit flow among multiple link-layer links.

2. The method of claim 1, wherein the source-destination address pairs comprise media access (MAC) address pairs.

3. The method of claim 1, wherein the source-destination address pairs comprise internet protocol (IP) address pairs.

4. The method of claim 1, wherein the source-destination address pairs include other packet characteristics such as UDP or TCP port numbers.

5. The method of claim 1, wherein source and destination address locations are learned so that flow establishment efficiency and bandwidth utilization.

6. The method of claim 1, wherein when source and destination address location moves are detected, flows associated with the moved addresses are removed.

7. The method of claim 1, wherein flow and address tables are aged when not in use so that their resources are returned to the system.

8. The method of claim 1, further comprising encoding sequence information into the data packets without changing packet size.

9. The method of claim 1, further comprising modifying an Ethernet type field to identify a packet containing specific transport protocol or transport data types that have modification.

10. The method of claim 1, further comprising:
before a data packet is transmitted, overwriting a checksum field of an internet protocol (IP) header to insert a sequence number indicative of a serial position of the data packet within the transmit flow; and
after the data packet is received by a receiving transport unit, re-calculating a checksum and rewriting the checksum field of the IP header.

11. The method of claim 10, wherein the sequence number is less than sixteen bits in length, and an extra bit in the checksum field is used as a flag.

12. The method of claim 1, further comprising:
before a data packet is transmitted, overwriting a type of service (TOS) field of an internet protocol (IP) header to insert a sequence number indicative of a serial position of the data packet within the transmit flow; and
after the data packet is received by a receiving transport unit, restoring the TOS field of the IP header.

13. The method of claim 12, wherein the sequence number is less than eight bits in length, and an extra bit in the TOS field is used as a flag.

14. The method of claim 1, further comprising insertion of a four byte data field to modify an original Ethernet type of a data packet, and insertion of a sequence number indicative of a serial position of the data packet within the transmit flow and, after the data packet is received by a receiving transport unit, removing the inserted four bytes and restoring the original Ethernet type.

15. The method of claim 1 further comprising use of specific flow types to determine flow characteristics, including packet priority, queuing length, credit issued, and retransmission time.

16. The method of claim 1, further comprising:
receiving acknowledgement (ACK) packets which indicate a next expected sequence range, wherein the ACK packets further indicate an amount of credit available to transmit further data packets.

17. The method of claim 1, further comprising:
measuring a dynamically-changing latency of the links; and
encoding latency information into acknowledgement packets to dynamically change load balance ratios for individual links among the multiple links being used for the same transmit flow.

18. The method of claim 17, further comprising:
periodic measurements of latency and bandwidth using a link-monitoring packet when data is not flowing.

19. The method of claim 18, further comprising:
monitoring of link availability by use of the link-monitoring packet.

20. The method of claim 17, further comprising:
adjusting measured latencies of the links to account for trends over time; and
using the adjusted latencies in said dynamic changing of the load balance ratios.

21. The method of claim 17, further comprising:
re-using said latency measurements for dynamic bandwidth determinations; and
encoding bandwidth information into the acknowledgement packets.

22. The method of claim 17, further comprising:
use of the individual links on a round robin basis according to a transmission ratio based on latency measurements.

23. The method of claim 17, further comprising:
dynamically adjusting bandwidth and latency calculations based on retransmission of packets.

24. The method of claim 1, further comprising:
aggregating bandwidth from a plurality of link-layer links to provide a larger bandwidth for a transmit flow.

25. The method of claim 1, wherein the plurality of transport units are installed within a single building.

26. The method of claim 1, wherein the multiple link-layer links include wireless networking links.

27. The method of claim 1, wherein the multiple link-layer links include networking links over power lines.

28. The method of claim 1, wherein the multiple link-layer links include both wireless networking links and networking links over power lines.

29. The method of claim 1, wherein security of a transmit flow is provided by the transmit flow being spread amongst the multiple link-layer links so that access to any single link does not give access to only a portion of the transmit flow.

30. The method of claim 1, further comprising:
re-sending a packet if the packet is not acknowledged before an interrupt from a re-transmission timer.

31. The method of claim 30, wherein reliability of a transmit flow is enhanced by said re-sending of the packet.

32. The method of claim 1, further comprising:
queuing lower priority packets even if bandwidth is available to reserve available bandwidth for higher priority packets.

33. An apparatus for transporting data packets to another apparatus, the apparatus comprising:
means for creating transmit flows which are associated with a source-destination address pair for new data streams received from outside a network of the transport units;
means for providing a separate sequence space for each transmit flow; and
means for spreading the transmission of the data packets belonging to a same transmit flow among multiple link-layer links.
